(19) United States
(12) Patent Application Publication
(10) Pub. No.: US 2022/0029161 A1
(43) Pub. Date: Jan. 27, 2022

(54) CATHODE MATERIALS FOR USE IN LITHIUM CELLS AND BATTERIES

(71) Applicant: UCHICAGO ARGONNE, LLC, Chicago, IL (US)

(72) Inventors: Michael M. THACKERAY, Naperville, IL (US); Eungje LEE, Naperville, IL (US); Jason R, CROY, Plainfield, IL (US); Joseph A. LIBERA, Clarendon Hills, IL (US); Kyojin KU, Daejeon (KR)

(73) Assignee: UCHICAGO ARGONNE, LLC, Chicago, IL (US)

(21) Appl. No.: 17/351,944

(22) Filed: Jun. 18, 2021

Related U.S. Application Data
(63) Continuation-in-part of application No. 17/313,752, filed on May 6, 2021.
Application No. 17/313,752 is a continuation-in-part of application No. 17/136,234, filed on Dec. 29, 2020.
(60) Provisional application No. 63/055,993, filed on Jul. 24, 2020.

(51) Int. Cl. H01M 4/525; H01M 4/505; H01M 4/66; H01M 10/0525; H01M 4/62; H01M 4/36

(52) U.S. Cl. CPC H01M 4/525; H01M 4/505; H01M 4/366; H01M 10/0525; H01M 4/623; H01M 4/663

(57) ABSTRACT

Lithium-manganese-nickel-oxide electrode materials are described herein, which are crystalline, structurally-integrated, lithium-metal-oxides of empirical formula LiM¹O₂ wherein M¹ comprises a combination of Mn and Ni transition metal ions; the crystal structure of the materials comprises domains of a disordered lithiated-spinel component, a disordered layered component, and optionally a disordered rock salt component, in which the oxygen lattice of the components is cubic-close packed. In general, the Mn:Ni ratio in the lithiated-spinel structures described herein is less than 2:1 and preferably close to 1:1. Preferably, M¹ is M²_{(1-w)}M³_{w}, wherein M² is a combination of Mn and Ni transition metal ions in a ratio of Mn to Ni ions of about 2:1 to about 1:1; M³ is one or more metal cations selected from the group consisting of an Al cation, a Ga cation, a Mg cation, a Ti cation; and a Co cation; and 0<w≤0.5.

### CROSS-REFERENCE TO RELATED APPLICATIONS

This application is a continuation in part of U.S. Ser. No. 17/313,752, filed on May 6, 2021, which is a continuation-in-part of U.S. Ser. No. 17/136,234, filed on Dec. 29, 2020, which claims the benefit of U.S. Provisional Application Ser. No. 63/055,993, filed on Jul. 24, 2020, each of which is incorporated herein by reference in its entirety.

### CONTRACTUAL ORIGIN OF THE INVENTION

The United States Government has rights in this invention pursuant to Contract No. DE-ACO2-06CH11357 between the United States Government and UChicago Argonne, LLC representing Argonne National Laboratory.

### FIELD OF THE INVENTION

This invention relates to electrode materials useful for rechargeable lithium-based cells and battery systems.

### BACKGROUND

Today, rechargeable lithium-ion batteries (LIBs) command a multi-billion-dollar industry. LIBs operate by shuttling lithium ions between the negative electrode (the anode) and the positive electrode (the cathode) during discharge and charge. Well-known examples of anode materials are carbon, particularly graphite, and the lithium-titanate spinel, Li₄Ti₅O₁₂ (LTO). Well-known cathode products include materials with layered structures, compositional variations of the lithium-manganese-oxide spinel, and lithium-iron-phosphate, LiFePO₄ (LFP), which has an olivine-type structure. Examples of layered materials include LiCoO₂ (LCO), LiNi_{0.8}Co_{0.15}Al_{0.05}O₂ (NCA) and various lithium-nickel-manganese-oxide (NMC) compositions such as LiNi_{0.6}Co_{0.2}Mn_{0.2}O₂ (NMC622), LiNi_{0.33}Co_{0.33}Mn₀₃₃O₂ (NMC111), and lithium-rich variants, Li₁₊ₓM₁₋ₓO₂ (M=Ni, Mn, Co), alternatively designated in composite notation as wLi₂MnO₃⋅(1−w)LiMO₂. Examples of lithium-manganese-oxide spinel-type materials include LiMn₂O₄ (LMO), and the lithium-rich spinel Li_{1.03}Mn_{1.97}O₄. These materials represent electrodes, i.e., both anodes and cathodes, in their stable discharged state, thereby enabling the safe assembly of lithium-ion cells and batteries, as well as the safe transport of these products from manufacturer to customer across the globe.

Gummow et al. reported the discovery of a new polymorphic form of lithium-cobalt-oxide (LiCoO₂) in the Materials Research Bulletin, Volume 27, pages 327-337 (1992). This compound was designated LT-LiCoO₂ because it was synthesized at a relatively low temperature (LT) of 400° C., compared to the previously known layered LiCoO₂, which is prepared at a significantly higher temperature (HT), typically 900° C., i.e., HT-LiCoO₂. Gummow et al. also reported in Solid State Ionics, Volume 53-56, pages 681-687 (1992) that nickel could be substituted for cobalt in the LT-LiCo₁₋ₓNiₓO₂ system over the range (0<x≤0.2). From an X-ray structural analysis, it was concluded by Rossen et al. in Solid State Ionics, Volume 62, pages 53-60 (1993) that LT-LiCoO₂ had a lithiated-spinel structure, while the refinements of Gummow et al. in the Materials Research Bulletin, Volume 28, pages 235-246 (1993) suggested that LT-LiCoO₂ samples had a predominant lithiated-spinel-like structure that deviated from the ideal spinel arrangement of cations.

More recently, Lee et al. in ACS Applied Energy Materials, Volume 2, pages 6170-6175 (2019) revealed that Al-substitution for cobalt is also possible in LT-LiCo₁₋ₓAlₓO₂ for (0<x<0.5) but, in this case, the electrochemical signature differs from that provided by LT-LiCoO₂ and LT-LiCo₁₋ₓNiₓO₂ lithiated-spinel electrodes, exhibiting single-phase behavior on lithium extraction, rather than the typical two-phase behavior expected of spinel electrodes. A structural refinement of LT-LiCo_{0.85}Al_{0.15}O₂ (x=0.15) by Lee et al. indicated that this behavior could be attributed to a small amount of cation disorder on the octahedral sites of the lithiated-spinel LT-LiCo₁₋ₓAlₓO₂ structure. Consequently, these slightly disordered lithiated-spinel LT-LiCo₁₋ₓAlₓO₂ materials can be defined as having slightly disordered rock salt structures. Like layered LiCoO₂, LT-LiCoO₂ and substituted derivatives are discharged cathodes. Lithium-ion cells with these cathode materials coupled to graphite (carbon) anodes can therefore be assembled safely in the discharged state, i.e., when all the lithium required for the electrochemical reaction is contained in the cathode. Such cells provide an attractive operating cell voltage of approximately 3.5 V.

Cobalt-containing lithiated-spinel electrode materials, for example, LiCo₁₋ₓMₓO₂, in which M is one or more metal ions, such as Ni and/or Al, are also of interest as stabilizers for layered lithium-rich and manganese-rich wLi₂MnO₃●(1−w)LiMO₂(M=Ni, Mn, and Co; i.e., NMC) electrodes, as described by Lee et al. in Applied Materials & Interfaces, Volume 8, pages 27720-27729 (2016). An advantage of these electrodes is that both lithiated-spinel and layered wLi₂MnO₃●(1−w)LiMO₂ components have a rock salt composition, in which the number of cations equals the number of anions, thereby facilitating their structural integration, particularly when the two components have closely-matched crystallographic lattice parameters.

Furthermore, the discovery of LT-LiCo₁₋ₓAlₓO₂ electrode materials has heightened interest in developing all-solid-state ‘spinel-spinel’ cells, which can be assembled in their discharged state, for example, by coupling a Li₄Ti₅O₁₂ spinel anode to a lithiated-spinel LT-LiCo₁₋ₓAlₓO₂ cathode with an appropriate lithium-ion conducting solid electrolyte, such as a solid inorganic electrolyte or a solid polymer electrolyte.

The generic family of materials with a spinel-type structure is broad and diverse. Numerous spinel-type compositions are found in nature while many others can be prepared synthetically in the laboratory, usually at elevated temperatures well above room temperature. The lithium spinels, such as LiMn₂O₄, Li₄Mn₅O₁₂, LiMn_{1.5}Ni_{0.5}O₄, and Li₄Ti₅O₁₂, which are of interest as electrodes for Li-ion battery applications, are typically prepared at temperatures between 400 and 900° C. By contrast, lithiation of the above-mentioned spinels to form lithiated-spinel products has to be conducted at room temperature or at slightly higher temperatures, e.g., 50° C., by chemical reactions, for example with butyl lithium, or by electrochemical reactions in an inert atmosphere because these lithiated-spinel structures are unstable at higher temperatures, particularly if heated in air or oxygen. In this respect, the family of lithiated cobalt-containing spinels, LiCo₁₋ₓMₓO₂, is distinct because they can be prepared at a moderately high temperature (for example, 400-500° C.) in air or oxygen, thereby offering the possibility of incorporating them as stabilizing components during the preparation of ‘layered-layered’ wLi₂MnO₃●(1−w)LiMO₂ (M=Ni, Mn, and Co; “NMC”) electrode materials.

Of the cathode materials discussed above, LCO, NCA and NMC materials dominate the current global cathode materials market. All of these cathode materials contain cobalt, which is the most expensive and least abundant cathode component used in lithium-ion batteries. Major international efforts are therefore underway to find less expensive nickel-rich and manganese-rich alternatives that are cobalt-free, without compromising the electrochemical performance of lithium-ion cells. This has been a daunting task.

The materials, electrodes, cells and batteries described herein address the need for new cobalt-free, lithium-metal-oxide electrode structures and compositions.

### SUMMARY

Currently, there is great interest in developing new materials for lithium-ion cathodes, which are either low-Co, Co-free, or which contain Co but have other desired properties (e.g., improved cycling stability, improved coulombic efficiency; improved specific capacity, and the like relative to lithium cobalt oxide (LCO).

The cobalt-free cathode materials described herein have a lithiated-spinel-type structure. These novel materials open the door to the development and exploitation of lower cost and safer cobalt-free electrode materials for next generation lithium-ion cells and batteries. The cobalt-free lithiated spinel materials described herein have the general empirical formula LiMnₓNi_{y}M_{z}O₂, in which x+y+z=1, 0<x<1.0, 0<y<1.0, 0≤z≤0.5, or alternatively in lithiated-spinel notation, Li₂Mn₂ₓNi_{2y}M_{2z}O₄, and in which M is selected from one or more metal cations, excluding Mn, Ni and Co. Preferably, M comprises Mg, Al, Ga, a combination of Mg and Ti in a 1:1 ratio, or a combination thereof. In general, the Mn:Ni ratio in the lithiated-spinel structures described herein is less than 2:1 and greater than 1:2, preferably close to 1:1, and more preferably 1:1.

In one aspect, cobalt containing lithium metal oxide materials described herein have a lithiated spinel-type structure (preferably predominately lithiated spinel; i.e., the material comprises greater than 50 mol % of the lithiated spinel structure; e.g., greater than 55 mol %, greater than 60 mol %, greater than 70 mol %, greater than 80 mol %, or 90 mol % of the lithiated spinel structure) and which have an overall empirical formula of LiMnₓNi_{y}M_{z}O₂; wherein M comprises Co and, optionally, other metals besides manganese and nickel; x+y+z=1; 0<x<1.0; 0<y<1.0; and 0≤z≤0.5; in the Mn and Ni are present in a molar Mn:Ni ratio in the range of about 1:2 to about 2:1. In some embodiments, z≤0.2, or z≤0.4, or z≤0.5; and 0.05≤z, or 0.1≤z, or 0.15≤z. For example, in some embodiments, 0≤z≤0.2, or 0.05≤z≤0.2, or 0.1≤z≤0.2, or 0.15≤z≤0.2, or 0≤z≤0.4, or 0.05≤z≤0.4, or 0.1≤z≤0.4, or 0.15≤z≤0.4, or 0.2≤z≤0.4, or 0.3≤z≤0.4.

In another aspect, lithium-manganese-nickel-oxide electrode materials for lithium cells and batteries, notably rechargeable Li-ion batteries, are described herein, which are crystalline, structurally-integrated, lithium-metal-oxides of empirical formula LiM¹O₂ wherein M¹ comprises a combination of Mn and Ni transition metal ions; the crystal structure of the materials comprises domains of a disordered lithiated-spinel component, a disordered layered component, and optionally a disordered rock salt component, in which the oxygen lattice of the components is cubic-close packed. In general, the Mn:Ni ratio in the lithiated-spinel structures described herein is less than about 2:1, and preferably about 1:1 (i.e., 1.05:1 to 0.95:1 , or 1.02:1 to 0.98:1, or 1.01:1 to 0.99:1). Optionally, the lithium-manganese-nickel-oxide electrode materials can be blended or structurally-integrated with other cathode materials and structures. In some embodiments, M¹ is M²_{(1-w)}M³_{w}, such that the material has the empirical formula LiM²_{(1-w)}M³_{w}O₂, wherein M² is a combination of Mn and Ni transition metal ions in a ratio of Mn to Ni ions of about 2:1 to about 1:1; M³ is one or more metal cations selected from the group consisting of an Al cation, a Ga cation, a Mg cation, a Ti cation; and a Co cation; and 0<w≤0.5.

In yet another aspect, a method for preparing a material of formula LiM²_{(1-w)}M³_{w}O₂ is described herein. The method comprises the steps of (a) atomizing a precursor solution with oxygen to form liquid droplets; (b) spraying the liquid droplets into a methane/oxygen pilot flame of a flame-spray pyrolysis (FSP) unit to vaporize and oxidize the metal salts to produce a precursor powder; and (c) heating the precursor powder in air at a selected temperature in the range of about 400 to about 650° C. (preferably 400 to 600° C.) to form the material of empirical formula LiM²_{(1-w)}M³_{w}O₂; wherein the precursor solution comprises stoichiometrically-required amounts of a Li salt, a M² salt, and a M³ salt dissolved in non-aqueous solvent or an aqueous solvent, wherein optionally, the lithium salt is present in a molar excess of less than about 10 mol % ; M² is a combination of Mn and Ni transition metal ions in a ratio of Mn to Ni ions of about 2:1 to about 1:1; M³ is one or more metal cations selected from the group consisting of an Al cation, a Ga cation, a Mg cation, a Ti cation; and a Co cation; and 0<w≤0.5.

The following non-limiting embodiments of the materials and methods described herein are provided below to illustrate certain aspects and features of the compositions and methods described herein.

Embodiment 1 is a cobalt-free lithium battery electrode active material of empirical formula LiMnₓNi_{y}M_{z}O₂; the material comprising a lithiated spinel structure; wherein M comprises one or more metal cations other than manganese, nickel and cobalt, x+y+z=1, 0<x<1.0, 0<y<1.0, 0≤z≤0.5; and having a molar Mn:Ni ratio in the range of about 1:2 to about 2:1.

Embodiment 2 comprises the electrode active material of embodiment 1, wherein the Mn:Ni ratio is about or equal to 1:1.

Embodiment 3 comprises the electrode active material of embodiment 1 or embodiment 2, wherein M comprises one or more metal cation selected from the group consisting of an Al cation, a Ga cation, and a combination of Mg and Ti cations.

Embodiment 4 comprises the electrode active material of any one of embodiments 1 to 3, wherein at least two of the Li, Mn, Ni and M cations in the lithiated spinel are partially disordered over the octahedral sites of the lithiated-spinel structure.

Embodiment 5 is the electrode active material of any one of embodiments 1 to 4, wherein the lithiated-spinel structure contains cation and/or anion defects or deficiencies.

Embodiment 6 is the electrode active material of any one of embodiments 1 to 5, wherein the lithium, oxygen, and/or total non-lithium metal content of the lithiated-spinel composition LiMnₓNi_{y}M_{z}O₂ varies by up to about 5 percent from an ideal 1:1:2 respective elemental stoichiometry.

Embodiment 7 is the electrode active material of any one of embodiments 1 to 6, further comprising fluorine in place of a portion of the oxygen in the LiMnₓNi_{y}M_{z}O₂; wherein less than 10 mole percent of the oxygen is replaced by fluorine.

Embodiment 8 is an electrode active composition for an electrochemical cell comprising a first cobalt-free electrode active material with a lithiated spinel structure mechanically blended with or structurally integrated with or a second electrode active material; wherein the first electrode active material has the empirical formula LiMnₓNi_{y}M_{z}O₂; wherein M comprises one or more metal cations other than manganese, nickel and cobalt; x+y+z=1; 0<x<1.0; 0<y<1.0; 0≤z≤0.5; and having a molar Mn:Ni ratio in the range of about 1:2 to about 2:1; and the second electrode active material comprises one or more cobalt-containing lithium metal oxide material.

Embodiment 9 comprises the electrode active material of embodiment 8, wherein the cobalt-containing lithium metal oxide material comprises LiCoO₂ with a layered-type structure and/or LiCoO₂ with a lithiated-spinel-type structure.

Embodiment 10 comprises the electrode active material of embodiment 8 or embodiment 9, wherein Co comprises less than about 33 mol % of non-lithium metal ions in the electrode active material.

Embodiment 11 comprises the electrode active material of any one of embodiments 8 to 10, wherein Co comprises less than 20 mol % of non-lithium metal ions in the electrode active material.

Embodiment 12 comprises the electrode active material of any one of embodiments 8 to 11, wherein Co comprises less than 10 mol % of the non-lithium metal ions.

Embodiment 13 comprises the electrode active material of any of embodiments 8 to 12, wherein the lithiated-spinel structure contains cation and/or anion defects or deficiencies.

Embodiment 14 is an electrode for a lithium electrochemical cell comprising particles of the electrode active material of any one of embodiments 1 to 13 in a binder matrix coated on a current collector.

Embodiment 15 comprises the electrode of embodiment 14, wherein the current collector comprises a metal or carbon material.

Embodiment 16 comprises the electrode of embodiment 15, wherein the current collector comprises a conductive carbon fiber paper.

Embodiment 17 comprises the electrode of embodiment 15, wherein the current collector comprises aluminum foil.

Embodiment 18 comprises the electrode of any one of embodiments 14 to 17, wherein the binder matrix comprises poly(vinylidene difluoride).

Embodiment 19 comprise the electrode of any one of embodiments 14 to 18, wherein the electrode further comprises particles of a conductive carbon material mixed with the electroactive material in the binder matrix.

Embodiment 20 is an electrochemical cell comprising an anode, a cathode, and a lithium-containing electrolyte contacting the anode and cathode, wherein the cathode comprises the electrode of any one of embodiments 14 to 19.

Embodiment 21 is a battery comprising a plurality of electrochemical cells of embodiment 20, electrically connected in series, in parallel, or in both series and parallel.

Embodiment 22 is a method for preparing the electrode active material of any one of embodiments 1 to 7, comprising heating a mixture of precursor salts at a temperature in the range of about 200 to about 600° C. in an oxygen-containing atmosphere (e.g., air); wherein the precursor salts comprises salts of Li, Mn, Ni and M cations with anions selected from the group consisting of carbonate, hydroxide, oxide, and nitrate; and the Li, Mn, Ni and M salts are present in a stoichiometric ratio selected to provide a target lithiated spinel of formula LiMnₓNi_{y}M_{z}O₂; wherein M comprises one or more metal cations other than manganese, nickel and cobalt, x+y+z=1, 0<x<1.0, 0<y<1.0, 0≤z≤0.5; and having a molar Mn:Ni ratio in the range of about 1:2 to about 2:1.

Embodiment 23 comprises the method of embodiment 22, wherein the mixture of precursor salts temperature is in the range of about 400 to 600° C.

Embodiment 24 comprises the method of embodiment 22 or embodiment 23, wherein the lithium salt is lithium carbonate, and the Ni, Mn, M salts are single or mixed metal hydroxides of Ni, Mn, and M metal cations.

Embodiment 25 comprises an electrode active material of empirical formula LiMnₓNi_{y}M_{z}O₂; the material comprising (preferably predominately comprising) a lithiated spinel structure; wherein M comprises Co and, optionally, other metals besides manganese and nickel; x+y+z=1; 0<x<1.0; 0<y<1.0; 0≤z≤0.5; and having a molar Mn:Ni ratio in the range of about 1:2 to about 2:1. In some embodiments, 0≤z≤0.2, or 0.05≤z≤0.2, or 0.1≤z≤0.2, or 0.15≤z≤0.2, or 0≤z≤0.4, or 0.05≤z≤0.4, or 0.1≤z≤0.4, or 0.15≤z≤0.4, or 0.2≤z≤0.4, or 0.3≤z≤0.4.

Embodiment 26 comprises the electrode active material of embodiment 25, wherein 0≤z≤0.1.

Embodiment 27 comprises the electrode active material of embodiment 25 or 26, wherein at least two of the Li, Mn, Ni and M cations in the lithiated spinel are partially disordered over the octahedral sites of the lithiated-spinel structure.

Embodiment 28 is the electrode active material of any one of embodiments 25 to 27, wherein the lithiated-spinel structure contains cation and/or anion defects or deficiencies.

Embodiment 29 is the electrode active material of any one of embodiments 25 to 28, wherein the lithium, oxygen, and/or total non-lithium metal content of the lithiated-spinel composition LiMnₓNi_{y}M_{z}O₂ varies by up to about 5 percent from an ideal 1:1:2 respective elemental stoichiometry.

Embodiment 30 is the electrode active material of any one of embodiments 25 to 29, further comprising fluorine in place of a portion of the oxygen in the LiMnₓNi_{y}M_{z}O₂; wherein less than 10 mole percent of the oxygen is replaced by fluorine.

Embodiment 31 is the electrode active material of any one of embodiments 25 to 30 mechanically blended with or structurally integrated with another different electrode active material.

Embodiment 32 comprises an electrode active material comprising particles of the electrode active material of any one of embodiments 1 to 13 and 25 to 31 coated with a metal-oxide, a metal fluoride or a metal phosphate layer.

Embodiment 33 comprises the electrode active material of embodiment 32, wherein the metal oxide layer is a lithiated-spinel LiCo₁₋ₓAlₓO₂.

Embodiment 34 is an electrode active material comprising the electrode active material of any one of the embodiments 1 to 13 and 25-31 as a protective surface coating on an underlying lithium-metal-oxide electrode material.

Embodiment 35 comprises the lithium-metal-oxide electrode material of embodiment 34, wherein the underlying lithium-metal-oxide material has a layered or spinel structure.

Embodiment 36 is an electrode for a lithium electrochemical cell comprising particles of the electrode active material of any one of embodiments 25 to 35 in a binder matrix coated on a current collector.

Embodiment 37 comprises the electrode of embodiment 36, wherein the current collector comprises a metal or carbon material.

Embodiment 38 comprises the electrode of embodiment 37, wherein the current collector comprises a conductive carbon fiber paper.

Embodiment 39 comprises the electrode of embodiment 37, wherein the current collector comprises aluminum foil.

Embodiment 40 comprises the electrode of any one of embodiments 36 to 39, wherein the binder matrix comprises poly(vinylidene difluoride).

Embodiment 41 comprise the electrode of any one of embodiments 36 to 40, wherein the electrode further comprises particles of a conductive carbon material mixed with the electroactive material in the binder matrix.

Embodiment 42 is an electrochemical cell comprising an anode, a cathode, and a lithium-containing electrolyte contacting the anode and cathode, wherein the cathode comprises the electrode of any one of embodiments 36 to 41.

Embodiment 43 is a battery comprising a plurality of electrochemical cells of embodiment 42, electrically connected in series, in parallel, or in both series and parallel.

Embodiment 44 comprises a method for preparing the electrode active material of embodiment 25 to 29, comprising heating a mixture of precursor salts at a temperature in the range of about 200 to about 600° C. in an oxygen-containing atmosphere; wherein the precursor salts comprises salts of Li, Mn, Ni and M cations with anions selected from the group consisting of carbonate, hydroxide and nitrate, and the Li, Mn, Ni and M salts are present in a stoichiometric ratio selected to provide a target lithiated spinel of formula LiMnₓNi_{y}M_{z}O₂; wherein M comprises Co and, optionally, other metal cations besides manganese and nickel; x+y+z=1; 0<x<1.0; 0<y<1.0; 0≤z≤0.5; and having a molar Mn:Ni ratio in the range of about 1:2 to about 2:1. In some embodiments, 0≤z≤0.2, or 0.05≤z≤0.2, or 0.1≤z≤0.2, or 0.15≤z≤0.2, or 0≤z≤0.4, or 0.05≤z≤0.4, or 0.1≤z≤0.4, or 0.15≤z≤0.4, or 0.2≤z≤0.4, or 0.3≤z≤0.4.

Embodiment 45 is a crystalline, structurally-integrated, lithium-metal-oxide composite electrode material of empirical formula LiM¹O₂, wherein M¹ comprises a combination of Mn and Ni transition metal ions in a ratio of Mn to Ni ions of about 2:1 to about 1:1; the crystal structure of the material of empirical formula LiM¹O₂ comprises domains of a disordered lithiated-spinel component, a disordered layered component, and a disordered rock salt component, in which the oxygen lattice of the components is cubic-close packed, and in which greater than 0 percent and less than 20 percent (e.g., about, or up to about 1, 2, 3, 4, 5, 6, 7, 8, 9, 10, 11, 12, 13, 14, 15, 16, 17, 18, or 19%) of lithium ions of the lithiated spinel and layered components are disordered among the octahedral sites normally occupied by the transition metal ions, and a corresponding percentage of the transition metal ions are disordered among the octahedral sites normally occupied by lithium ions, in fully-ordered, lithiated spinel and layered structures. In some preferred embodiments greater than 10 percent and less than 20 percent of the lithium ions of the lithiated spinel and layered components are disordered among the octahedral sites normally occupied by the transition metal ions, and a corresponding percentage of the transition metal ions are disordered among the octahedral sites normally occupied by lithium ions, in fully-ordered, lithiated spinel and layered structures.

Embodiment 46 is the material of Embodiment 1, wherein greater than 10 percent and less than 20 percent (e.g., about 11 to 19, 15 to 18, or 16 to 17 percent) of the lithium ions of the lithiated spinel and layered component structures are disordered among the octahedral sites normally occupied by the transition metals, and a corresponding percentage of the transition metal ions are disordered among the octahedral sites normally occupied by lithium ions, in fully ordered, lithiated spinel and layered structures.

Embodiment 47 is the material of Embodiments 45 or 46, wherein M¹ comprises Mn and Ni ions in a ratio of Mn to Ni ions of about 1.5:1 to about 1:1.

Embodiment 48 is the material of any one of embodiments 45 to 47, wherein M¹ comprises Mn and Ni ions in a ratio of Mn to Ni ions of about 1.1:1 to about 1:1.

Embodiment 49 is the material of any one of embodiments 45 to 48, wherein M¹ comprises Mn and Ni ions in a ratio of about 1:1.

Embodiment 50 is the material of embodiment 49, wherein the disordered lithiated spinel and layered components of the material of formula LiM¹O₂ have X-ray diffraction (XRD) patterns in which the pattern of the disordered lithiated spinel component conforms to cubic space group symmetry Fd-3m with crystallographic formula: (Li_{0.83}M¹_{0.17})_{2(16c)}[Li_{0.83} M¹_{0.17}]_{2(16d)}]O₄₍₃₂ₑ₎, the oxygen ions are cubic-close packed, about 16 to about 17 percent of lithium ions that would be located in 16c octahedral sites in a fully ordered lithiated spinel structure are located in 16d sites, and about 16 to 17 percent of the transition metal ions that would normally be located in 16d octahedral sites in a fully ordered lithiated spinel structure are present in 16c sites; the XRD pattern of the disordered layered component conforms to trigonal space group symmetry R-3m with crystallographic formula (Li_{0.83} M¹_{0.17})₍₃ₐ₎[Li_{0.17} M¹_{0.83}]_{(3b)}]O_{2(6c)}, the oxygen ions are cubic-close-packed, about 16 to about 17 per cent of lithium ions that would normally be located in 3a octahedral sites in a fully ordered layered material are located in 3b octahedral sites, and about 16 to 17 percent of the transition metal ions that would normally be located in 3b octahedral sites in the fully ordered layered structure are present in 3a octahedral sites.

Embodiment 51 is the material of any one of embodiments 45 to 50, wherein M¹ in formula Li M¹O₂ is M²_{(1-w)}M³_{w}, M² is a combination of Mn and Ni transition metal ions; M³ is one or more other metal cations selected from the group consisting of an Al cation, a Ga cation, a Mg cation, a Ti cation; and a Co cation; and 0<w≤0.1.

Embodiment 52 is the material of embodiment 51, wherein M² is a combination of Mn and Ni transition metal ions in a Mn to Ni ratio of about 1:1 (i.e., 1.05:1 to 0.95:1, or 1.02:1 to 0.98:1, or 1.01:1 to 0.99:1).

Embodiment 53 is the material of embodiment 51 or 52, wherein M³ is an Al cation.

Embodiment 54 is the material of embodiment 51 or 52, wherein M³ is a Co cation.

Embodiment 55 is the material of any one of embodiments 45 to 54, wherein the lithium, M¹, and/or oxygen, content of the material varies by up to about 5 percent from an ideal 1:1:2 respective elemental stoichiometry.

Embodiment 56 is the material of any one of embodiments 45 to 55, wherein the cubic-close-packed oxygen lattice deviates from ideal cubic-close-packing such that the crystal symmetry of one or more of the components is lowered by an anisotropic variation of at least one lattice parameter length of the unit cell by up to about 5%. Isotropic refers to a property of a material which is independent of spatial direction, whereas anisotropic is direction dependent. These two terms are commonly used to explain the properties of the material in basic crystallography, as is well known in the art.

Embodiment 57 is the material of any one of embodiments 45 to 55, wherein the cubic-close-packed oxygen lattice deviates from ideal cubic-close-packing such that the crystal symmetry of one or more of the components is lowered by an anisotropic variation of at least one lattice parameter length of the unit cell by up to about 2%.

Embodiment 58 is the material of any one of embodiments 45 to 57, further comprising fluorine in place of a portion of the oxygen in the material of formula LiM¹O₂; wherein less than 10 atom percent of the oxygen is replaced by fluorine.

Embodiment 59 is an electrode active composition for an electrochemical cell comprising a first electrode active material mechanically blended with or structurally integrated with a second electrode active material, wherein the first electrode active material is the material of any one of embodiments 45 to 58, and the second electrode active material comprises one or more additional lithium metal oxide materials different from the first electrode active material.

Embodiment 60 is an electrode for a lithium electrochemical cell comprising particles of an electrode active material in a binder matrix coated on a metal or carbon current collector; wherein the electrode active material comprises the material of any one of embodiments 45 to 59.

Embodiment 61 is an electrochemical cell comprising an anode, a cathode, and a lithium-containing electrolyte contacting the anode and cathode, wherein the cathode comprises the electrode of embodiment 60.

Embodiment 62 is a battery comprising a plurality of electrochemical cells of embodiment 61 electrically connected in series, in parallel, or in both series and parallel.

Embodiment 63 is a crystalline, structurally-integrated, lithium-metal-oxide composite electrode material of empirical formula LiM²_{(1-w)}M³_{w}O₂, wherein M² is a combination of Mn and Ni transition metal ions in a ratio of Mn to Ni ions of about 2:1 to about1:1; M³ is one or more metal cations selected from the group consisting of an Al cation, a Ga cation, a Mg cation, a Ti cation; and a Co cation; and 0<w≤0.5; the crystal structure of the material of empirical formula LiM²_{(1-w)}M³_{w}O₂ comprises domains of a disordered lithiated-spinel component, a disordered layered component, and optionally a disordered rock salt component, in which the oxygen lattice of the components is cubic-close packed, and in which greater than 0 and less than 20 percent of lithium ions of the lithiated spinel and layered components are disordered among the octahedral sites normally occupied by the transition metal ions, and a corresponding percentage of the transition metal ions are disordered among the octahedral sites normally occupied by lithium ions, in fully-ordered, lithiated spinel and layered structures. In some embodiments, w≤0.2, or w≤0.3, or w≤0.4, or w≤0.5; and 0.05≤w, or 0.1≤w, or 0.15≤w, or 0.3≤w.

Embodiment 64 is the material of embodiment 63, wherein greater than 10 percent and less than 20 percent of the lithium ions of the lithiated spinel and layered component structures are disordered among the octahedral sites normally occupied by the transition metals, and a corresponding percentage of the transition metal ions are disordered among the octahedral sites normally occupied by lithium ions, in fully ordered, lithiated spinel and layered structures.

Embodiment 65 is the material of embodiment 63 or 64, wherein the ratio of Mn to Ni ions is about 1:1.

Embodiment 66 is the material of any one of embodiments 63 to 65, wherein the ratio of Mn to Ni ions is in the range of 1.05:1 to 0.95:1.

Embodiment 67 is the material of any one of embodiments 63 to 66, wherein the ratio of Mn and Ni ions is in the range of 1.02:1 to 0.98:1.

Embodiment 68 is the material of any one of embodiments 63 to 67, wherein M³ is Co and 0<w≤0.35.

Embodiment 69 is the material of any one of embodiments 63 to 68, wherein M³ is Co and 0.3<w≤0.35.

Embodiment 70 is the material of embodiment 69, wherein the ratio of Mn to Ni ions is about 1:1.

Embodiment 71 is the material of embodiment 69, wherein the ratio of Mn to Ni ions is in the range of 1.05:1 to 0.95:1.

Embodiment 72 is the material of embodiment 69, wherein the ratio of Mn to Ni is in the range of 1.02:1 to 0.98:1.

Embodiment 73 is the material of any one of embodiments 63 to 72, wherein the lithium, M², M², and/or oxygen content of the material varies by up to about 5 percent from an ideal 1:(1-w):w:2 respective elemental stoichiometry.

Embodiment 74 is the material of any one of embodiments 63 to 73, wherein the cubic-close-packed oxygen lattice deviates from ideal cubic-close-packing such that the crystal symmetry of one or more of the components is lowered by an anisotropic variation of at least one lattice parameter length of the unit cell by up to about 5%.

Embodiment 75 is the material of any one of embodiments 63 to 73, wherein the cubic-close-packed oxygen lattice deviates from ideal cubic-close-packing such that the crystal symmetry of one or more of the components is lowered by an anisotropic variation of at least one lattice parameter length of the unit cell by up to about 2%.

Embodiment 76 is the material of any one of embodiments 63 to 75, further comprising fluorine in place of a portion of the oxygen in the material of formula LiM²_{(1-w)}M³_{w}O₂; wherein less than 10 atom percent of the oxygen is replaced by fluorine.

Embodiment 77 is an electrode active composition for an electrochemical cell comprising a first electrode active material mechanically blended with or structurally integrated with a second electrode active material, wherein the first electrode active material is the material of any one of embodiments 63 to 76; and the second electrode active material comprises one or more additional lithium metal oxide materials different from the first electrode active material.

Embodiment 78 is an electrode for a lithium electrochemical cell comprising particles of an electrode active material in a binder matrix coated on a metal or carbon current collector; wherein the electrode active material comprises the material of any one of embodiments 63 to 76.

Embodiment 79 is an electrochemical cell comprising an anode, a cathode, and a lithium-containing electrolyte contacting the anode and cathode, wherein the cathode comprises the electrode of embodiment 78.

Embodiment 80 is a battery comprising a plurality of electrochemical cells of embodiment 79 electrically connected in series, in parallel, or in both series and parallel. Embodiment 81 is a method for preparing a material of formula LiM²_{(1-w)}M³_{w}O₂; the method comprising the steps of (a) atomizing a precursor solution with oxygen to form liquid droplet; (b) spraying the liquid droplets into a methane/oxygen pilot flame of a flame-spray pyrolysis (FSP) unit to vaporize an oxidize the metal salts to produce a precursor powder; and (c) heating the precursor powder in air at a selected temperature in the range of about 400 to about 650° C. (preferably 400 to 600° C.) to form the material of empirical formula LiM²(1,)M³,,02; M² is a combination of Mn and Ni transition metal ions in a ratio of Mn to Ni ions of about 2:1 to about 1:1; M³ is one or more metal cations selected from the group consisting of an Al cation, a Ga cation, a Mg cation, a Ti cation; and a Co cation; and 0<w≤0.5; and wherein the precursor solution comprises a Li salt, a M² salt, and a M³ salt which are dissolved in a non-aqueous solvent or an aqueous solvent in stoichiometrically-required amounts required to achieve a target ratio of 1:(1-w):w:2, and optionally, the lithium salt is present in the precursor solution in a molar excess of less than about 10 mol %.

Embodiment 82 is the method of embodiment 81, wherein the precursor powder is heated at a selected temperature in the range of about 400 to about 600° C.

Embodiment 83 is the method of embodiment 81, wherein the precursor powder is heated at a selected temperature in the range of about 500 to about 600° C.

Embodiment 84 is the method of any one of embodiments 81 to 83, further comprising, before step (a), preparing the precursor solution by dissolving the Li salt, the M² salt, and the M³ salt in an aqueous solvent or a non-aqueous solvent; wherein optionally the Li salt is included in an excess of up to about 10 mol %.

Embodiment 84 is the method of any one of embodiments 81 to 84, wherein each of the Li salt, the M² salt, and the M³ salt is a salt of an organic acid.

Embodiment 85 is the method of any one of embodiments 81 to 84, wherein the organic acid is selected from the group consisting of acetic acid, propionic acid, and acetylacetic acid.

Embodiment 86 is the method of any one of embodiments 81 to 83, wherein the solvent is an organic solvent (e.g., a solvent selected from the group consisting of acetonitrile, 2-ethylhexanocid acid, and a combination thereof).

### BRIEF DESCRIPTION OF THE DRAWINGS

FIG. 1A depicts the X-ray diffraction pattern of LT-LiMn_{0.5}Ni_{0.5}O₂.

FIG. 1B depicts the observed XRD pattern of LT-LiMn_{0.5}Ni_{0.5}O₂ with cubic symmetry and the simulated XRD pattern of HT-LiMn_{0.5}Ni_{0.5}O₂ with trigonal symmetry.

FIG. 1C depicts the observed synchrotron XRD pattern of LT-LiMn_{0.5}Ni_{0.5}O₂.

FIG. 1D depicts the calculated synchrotron XRD pattern of a lithiated-spinel model, LT-LiMn_{0.5}Ni_{0.5}O₂, indexed to cubic Fd-3m symmetry.

FIG. 1E depicts the calculated synchrotron XRD pattern of a layered model, LT-LiMn_{0.5}Ni_{0.5}O₂, indexed to trigonal R-3m symmetry.

FIG. 2 depicts the voltage (V) vs. specific capacity (mAh/g) plots of a Li/LT-LiMn_{0.5}Ni_{0.5}O₂ cell.

FIG. 3 depicts the voltage (V) vs. specific capacity (mAh/g) plots of a graphite/LT-LiMn_{0.5}Ni_{0.5}O₂ cell.

FIG. 4 depicts the X-ray diffraction pattern of LT-LiMn_{0.45}Ni_{0.45}Al_{0.1}O₂.

FIG. 5 depicts the initial voltage (V) vs. specific capacity (mAh/g) plot of a Li/LT-LiMn_{0.45}Ni_{0.45}Al_{0.1}O₂ cell.

FIG. 6 depicts the specific capacity vs. cycle number plots of a Li/LT-LiMn_{0.45}Ni_{0.45}Al_{0.1}O₂ cell.

FIG. 7 depicts the X-ray diffraction pattern of a LT-LiMn_{0.5}Ni_{0.5}O₂+LT-LiCo_{0.75}Al_{0.25}O₂ electrode powder, blended in a 90:10 percent ratio, respectively.

FIG. 8 depicts the electrochemical profile of the initial discharge of a Li/LT-LiMn_{0.5}Ni_{0.5}O₂+LT-LiCo_{0.75}Al_{0.25}O₂ cell.

FIG. 9 depicts the specific capacity vs. cycle number plots of a Li/LT-LiMn_{0.5}Ni_{0.5}O₂+LT-LiCo_{0.75}Al_{0.25}O₂ cell.

FIG. 10 depicts the X-ray diffraction pattern of LT-LiMn_{0.475}Ni_{0.475}Co_{0.05}O₂.

FIG. 11 depicts the electrochemical profile of the initial discharge of a Li/LT-LiMn_{0.45}Ni_{0.45}Co_{0.1}O₂ cell.

FIG. 12 depicts the voltage (V) vs. specific capacity (mAh/g) plots of a Li/LT-LiMn_{0.475}Ni_{0.475}Co_{0.05}O₂ cell.

FIG. 13 depicts a schematic representation of an electrochemical cell.

FIG. 14 depicts a schematic representation of a battery consisting of a plurality of cells connected electrically in series and in parallel.

FIG. 15 depicts a high-resolution transmission electron microscope image of LT-LiMn_{0.5}Ni_{0.5}O₂.

FIG. 16 depicts the first three cycles of a Li/LT-LiMn_{0.5}Ni_{0.5}O₂ cell.

FIG. 17 depicts a dQ/dV plot of the 3^{rd} cycle of a Li/LT-LiMn_{0.5}Ni_{0.5}O₂ cell.

FIG. 18 depicts the cycling stability of a Li/LT-LiMn_{0.5}Ni_{0.5}O₂ cell when discharged and charged between 2.5-5.0 V; 2.5-4.7 V; and 2.5-4.2 V.

FIG. 19A depicts an X-ray diffraction patterns of a LiNi_{1/3}Mn_{1/3}Co_{1/3}O₂ electrode powder prepared by a flame-spray pyrolysis method (indicated as ‘bare’), and after heating in air at 400, 500, 600, 625 and 650° C.

FIG. 19B provides a detail of the X-ray diffraction patterns of FIG. 19A.

FIG. 19C provides a high-resolution scanning transmission electron microscopy (HR-STEM) image of an unheated (‘bare’) LiNi_{1/3}Mn_{1/3}Co_{1/3}O₂ electrode powder.

FIG. 19D provides a HR-STEM image of a LiNi_{1/3}Mn_{1/3}Co_{1/3}O₂ electrode powder after heating in air at 400° C.

FIG. 20 depicts the voltage profiles of Li/LiNi_{1/3}Mn_{1/3}Co_{1/3}O₂ cells containing LiNi_{1/3}Mn_{1/3}Co_{1/3}O₂ electrode powders heated to 400, 500, 625° C. when charged and discharged between 4.3-2.7 V.

### DETAILED DESCRIPTION

Materials with a spinel-type structure, as epitomized by the prototypic mineral spinel, having the formula MgAl₂O₄, are abundant in nature and they are diverse in their composition. For the lithium battery industry, lithium-metal-oxide electrodes with a spinel-type structure, such as lithium titanate, Li₄Ti₅O₁₂ (Li[Li_{1/3}Ti_{5/3}]O₄), and lithium manganate LiMn₂O₄ and substituted derivatives thereof, e.g., Li[Mn_{2-δ}Li_{δ}]O₄, can be prepared by a variety of synthetic techniques at elevated temperatures. High-temperature synthesis is important and necessary for fabricating electrode particles with an acceptably high packing density. On the other hand, it is well-known that lithiated spinels, such as Li₇Ti₅O₁₂ (Li₂[Li_{1/3}Ti_{5/3}]O₄) and Li₂[Mn₂]O₄ can be prepared electrochemically at room temperature and slightly elevated temperature (e.g., 60° C.). However, when heated at elevated temperatures, particularly in air or oxygen, these lithiated spinel structures are unstable and tend to transform to other structure types. Indeed, only a few examples of lithiated spinels that can be prepared at an elevated temperature of about 400° C. are known to exist, notably those in the family of lithiated-cobalt-oxide spinels LiCo₁₋ₓMₓO₂, alternatively in spinel notation, Li₂Co₂₋₂ₓM₂ₓO₄ (e.g., where M=Ni, Al, Ga), as described by Gummow et al. and by Lee et al. in references already provided herein.

As described herein, Co-free, lithiated-spinel electrode materials are described herein, which have the formula LiMnₓNi_{y}M_{z}O₂, alternatively Li₂Mn₂ₓNi_{2y}M_{2z}O₄ in lithiated-spinel notation, in which x+y+z=1, 0<x<1.0, 0<y<1.0, 0≤z≤0.5, and M is a metal cation excluding Mn, Ni and Co. The reversible electrochemical capacity of these electrodes is generated predominantly from redox reactions that occur on the nickel ions, as it does in layered LiMn_{0.5}Ni_{0.5}O₂ and spinel LiMn_{1.5}Ni_{0.5}O₄ electrodes, while the tetravalent Mn ions operate predominantly as electrochemically-inactive spectator ions during charge and discharge of the cell. The strategy uses the LiMn_{0.5}Ni_{0.5}O₂ composition as a building block to synthesize and stabilize a new family of Mn- and Ni-based lithiated-spinel electrode structures as emphasized in Table 1 in which the normalized and generalized lithiated-spinel notation, LiMnₓNi_{y}M_{z}O₂, is used for convenience to aid the discussion.

In a preferred embodiment, the Mn:Ni ratio in these lithiated-spinel structures is less than 2:1 and greater than 1:2, preferably close to 1:1, and more preferably 1:1, to yield fully-discharged LiMnₓNi_{y}M_{z}O₂ electrodes in which the Mn and Ni ions adopt tetravalent and divalent oxidation states, or oxidation states as close to those ideal values as possible. In another preferred embodiment, M is selected from one or more of Mg, Al and Ga or, alternatively, a combination of Mg and Ti in a 1:1 ratio also referred to herein as 1:1 Mg-Ti). In yet another embodiment; M can be a combination of two or more of Mg, Al, Ga, or 1:1 Mg-Ti.

The lithiated-spinel structures described herein may deviate slightly from their ideal stoichiometric composition by containing cation and/or anion defects or deficiencies, as is known for metal oxide structures. In this case, the sum of x+y+z in LiMnₓNi_{y}M_{z}O₂ may deviate slightly from 1 (e.g., up to about 5 mol % deviation), while the oxygen content may deviate slightly from 2 (e.g., up to about 5 mol % deviation). Moreover, it is well known that lithium metal oxides can be synthesized that are either slightly lithium-rich or slightly lithium-deficient, such as found within the Li₁₊ₓMn₂₋ₓO₄ spinel (0<x<0.33) and Li₁₋ₓMn₂O₄ (0<x<1) spinel systems, respectively. Thus, the lithiated spinel LiMnₓNi_{y}M_{z}O₂ electrode materials may deviate from ideal stoichiometry by up to about 5 mol % in the lithium, oxygen or total non-lithium metal content thereof.

In a further embodiment, it is known that F ions can be substituted for the O ions in lithium-metal-oxides, especially near surfaces or within bulk environments, notably Li-rich environments as well as in the presence of oxygen vacancies and local disorder within defect-containing oxides. These F ions can provide, for example, enhanced stability, particularly for Mn-containing compositions, against metal dissolution, surface damage, and reduced cycling and rate performance. Therefore, another aspect of the materials described herein includes LiMnₓNi_{y}M_{z}O_{2-δ}F_{δ} electrode materials in which 0<δ<0.1.

The term “spinel” as used herein in reference to metal oxide materials refers to a material having a spinel-type crystal structure. The prototype “spinel” is the mineral MgAl₂O₄. As explained in Thackeray, J. Am. Ceram. Soc; 1999; 82, 3347-54, spinels have a generic structure A[B₂]X₄ where A refers to cations in the 8a tetrahedral sites and B refers to cations in the 16d octahedral sites of the cubic space group symmetry Fd3̅m (sometimes written as Fd-3m or simply Fd3m, particularly in older literature due to the difficulty of typing a macron over the number 3). The X anions, such as oxygen anions, located at the 32e sites form a cubic-close-packed array. Thus, the prototypical spinel can be written in the following form, which identifies the sites of the various cations a within the spinel crystal structure: (A)₈ₐ[B₂]_{16d}O₄ (i.e., X=O) where the square brackets delineate crystallographically independent octahedral sites. There are 64 tetrahedral sites in a typical unit cell, one eighth of which are occupied by the A cations, and 32 octahedral sites, one half of which are occupied by the B cations within the unit cell. Lithium ions can be inserted into a spinel structure to form a product with rock salt stoichiometry, and which has a structure, referred to as a “lithiated spinel”, of formula LiAB₂O₄, alternatively Li[A]_{16c}[B₂]_{16d}O₄, i.e., in which the A cations are displaced from tetrahedral 8a sites of the normal spinel structure to octahedral 16c sites along with the added lithium.

Lithiated-spinel structures with the ideal spinel configuration of atoms also can be represented in spinel notation by the formula Li_{2(16c)}[M_{2(16d)}]O₄₍₃₂ₑ₎, where 16c and 16d refer to all the octahedral sites and 32e to the cubic-close-packed oxygen sites of the crystallographic space group, Fd-3m. This space group, is also adopted by the prototypic structure of the mineral ‘spinel’, Mg₍₈ₐ₎Al_{2(16d)}O₄₍₃₂ₑ₎, in which the magnesium ions occupy the tetrahedral 8a sites and aluminum the octahedral 16d sites and by the lithium-manganese-oxide spinel structure, Li₍₈ₐ₎Mn_{2(16d)}O₄₍₃₂ₑ₎, in which the lithium ions occupy the tetrahedral 8a sites and manganese ions the octahedral 16d sites. This cubic space group is used herein for convenience to simplify the structural discussion of the lithiated-spinel materials described herein and, particularly, because spinel and lithiated-spinel structures can adopt lower symmetry, as is the case for the spinel, Mn₃O₄, and the lithiated spinel, Li₂[Mn₂]O₄, respectively, both of which have tetragonal symmetry, I4₁/amd. The crystallographic symmetry of the cobalt-free lithiated-spinel structures described herein is therefore not restricted to one space group.

It should be noted that lithiated spinels, Li_{2(16c)}[M_{2(16d)}]O₄₍₃₂ₑ₎, can also be regarded as having a rock-salt-type structure because the positively charged Li and M cations occupy all the octahedral sites (16c and 16d) of a cubic-close-packed oxygen lattice. The materials may include ordered and/or partially-disordered lithiated-spinel (rock salt) LiMnₓNi_{y}M_{z}O₂ electrode structures (alternatively Li₂Mn₂ₓNi_{2y}M_{2z}O₄), in which the disorder occurs, for example, between the lithium ions on the octahedral 16c sites and the metal ions on the octahedral 16d sites of a structure with predominant lithiated-spinel character. Such disorder can result in structures with increasing layered character or, alternatively, to structures with a more random distribution of cations in localized regions of the electrode structure, thereby affecting the electrochemical signature and voltage profile of the cell during charge and discharge. Some localized disorder of the lithium and other metal ions between octahedral and tetrahedral sites may also be possible in these electrode structures.

During the electrochemical extraction of lithium during cell charging and reinsertion of lithium during cell discharge in the lithiated-spinel electrodes of described herein, the lithium ions diffuse predominantly through a 3-dimensional intersecting pathway of 8a tetrahedra and 16c octahedra (wherein 8a and 16c refer to crystallographic designations of specific spinel crystal lattice sites). It should, however, be recognized that any disorder of the Li, Mn, Ni or metal (M) ions, as well as the presence of a structurally-integrated layered component in the structure of the electrode material will likely affect these diffusion pathways and the profiles of the electrochemical charge and discharge reactions expected for ordered lithium-metal-oxide spinel electrodes, which are characterized by two-phase (constant voltage) behavior. It can therefore be understood that during electrochemical charge and discharge of the lithiated-spinel electrodes, the lithium-ions, in particular, will be disordered over both tetrahedral and octahedral sites of the structure.

The compositional space, structural features and atomic arrangements of the lithiated-spinel-related materials described herein are broad in scope, the electrochemical properties of which will be dependent on the selection of the metal cations, M, and the location of the electrochemically-active- and electrochemically-inactive metal ions within the ordered- or partially-disordered lithiated-spinel-related structures.

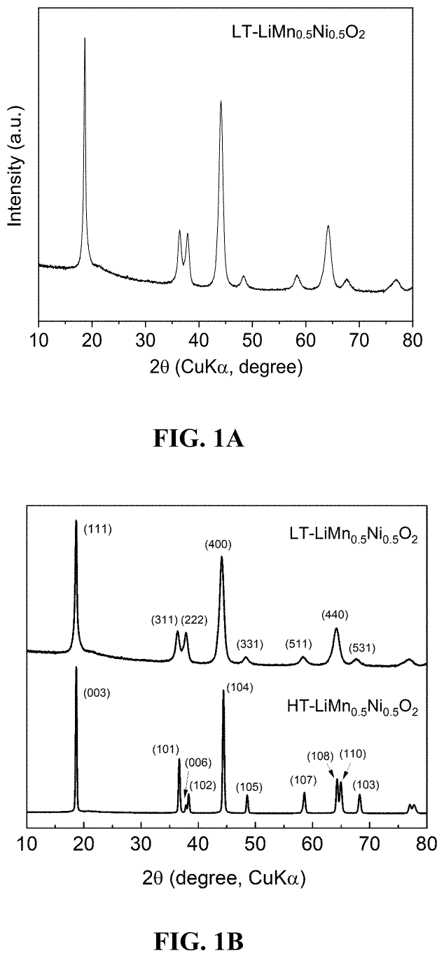

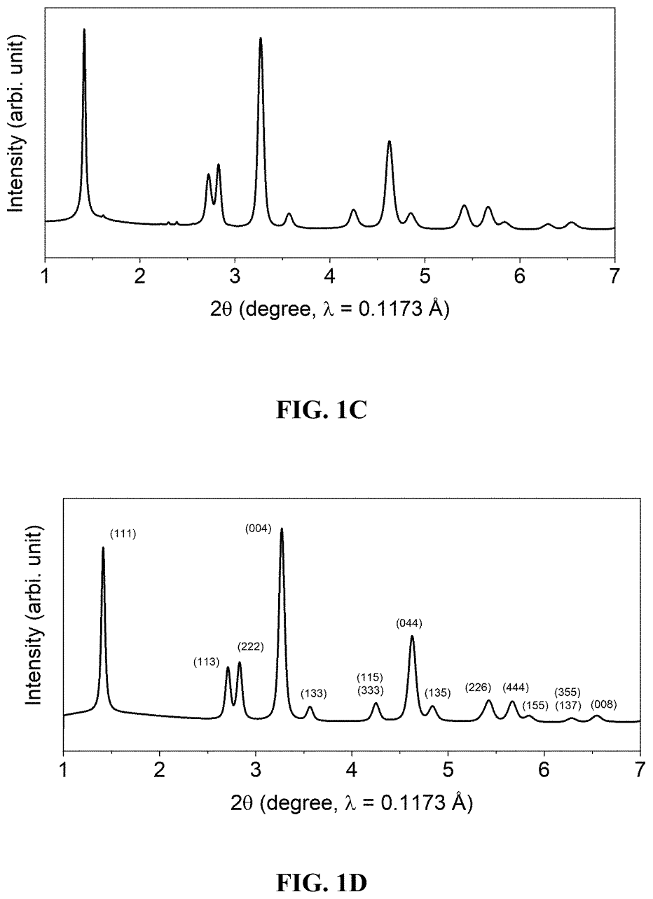

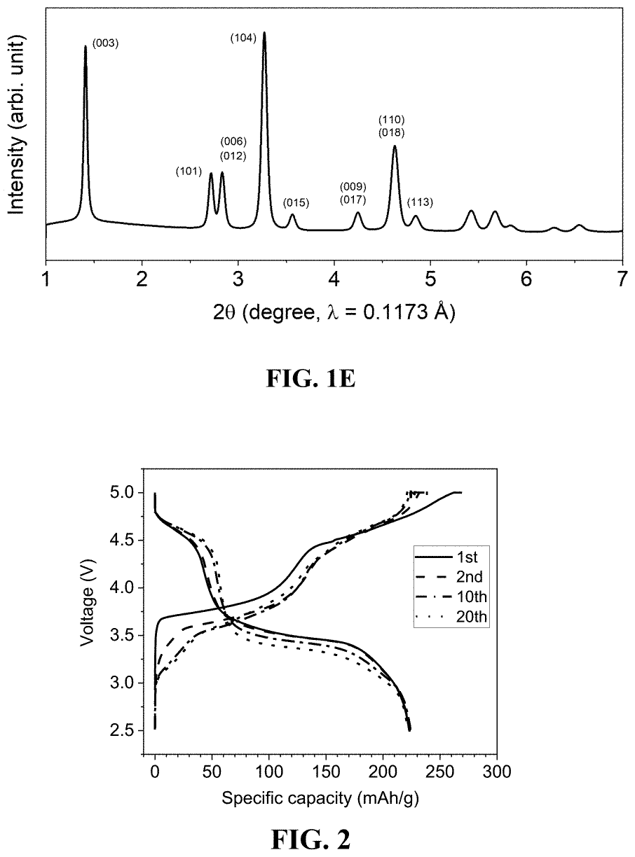

A further significant embodiment is the discovery of a remarkable crystallographic anomaly that was found to exist between a disordered lithiated-spinel LT-LiMn_{0.5}Ni_{0.5}O₂ structure described herein, alternatively designated LT-Li₂MnNiO₄ for convenience, and a disordered layered LT-LiMn_{0.5}Ni_{0.5}O₂ structure with the same chemical formula and composition overall, as described as follows. FIG. 1A shows the observed XRD pattern of a LT-Li₂MnNiO₄ sample, synthesized by a solid-state reaction of Li₂CO₃ and Mn_{0.5}Ni_{0.5}(OH)₂ precursors in air at 400° C. The diffraction peaks can be indexed to a cubic unit cell (space group=Fd-3m) with lattice parameter, a=8.217 Å. In contrast, the well-known, polymorphic layered structure, HT-LiMn_{0.5}Ni_{0.5}O₂ prepared at higher temperature, typically 1000° C., has a complex structure with overall trigonal symmetry, R3̅m (also referred to as R-3m), in which approximately 9% of the transition metals reside in the lithium layers, as described by Meng et al. in Chemistry of Materials, Volume 17, pages 2386-2394 (2005). This difference in crystallographic symmetry, which introduces more diffraction peaks in the XRD pattern of HT-LiMn_{0.5}Ni_{0.5}O₂ makes it extremely difficult to distinguish the high-symmetry (cubic) LT-Li₂MnNiO₄ product from the lower-symmetry (trigonal) product, HT-LiMn_{0.5}Ni_{0.5}O₂, the XRD pattern of which is reported by Meng et al. in the above-mentioned reference, and also shown in the simulated XRD pattern of HT-LiMn_{0.5}Ni_{0.5}O₂ in FIG. 1B.

A structural (Rietveld) refinement of the XRD pattern of a LT-Li₂MnNiO₄ sample (FIG. 1C) using synchrotron data obtained from the Advanced Photon Source at Argonne

National Laboratory not only confirmed that the peaks could be matched to a cubic structure (space group Fd-3m) but also that 17% of the Li ions on the 16c sites were exchanged with Mn/Ni ions on the 16d sites of an ideal, ordered-lithiated-spinel Li_{2(16c)}[M_{2(16d)}]O₄₍₃₂ₑ₎ structure (FIG. 1D). Constraining the Mn:Ni ratio to be 1:1 during the refinement yielded a disordered rock salt configuration with strong lithiated-spinel-type character, (Li_{0.83}M_{0.17})_{2(16c)}[Li_{0.17}M_{0.83}]_{2(16d)}O₄₍₃₂ₑ₎ (M=Mn, Ni) relative to the fully-ordered arrangement Li_{2(16c)}[Mn_{0.5}Ni_{0.5}]_{2(16d)}O₄₍₃₂ₑ₎. (See Table 2 in Example 6 for the full results of this refinement.) This level of Li/M site-exchange is significantly higher than it is in the Co-based lithiated-spinel materials, LT-LiCo₁₋ₓAlₓO₂, in which there is about 2% of site-exchange between the lithium and cobalt/aluminum ions, as reported by Lee et al., in ACS Applied Energy Materials, Volume 2, pages 6170-6175 (2019).

Surprisingly, a second Rietveld refinement of the XRD peaks of the LT-Li₂MnNiO₄ (LT-LiMn_{0.5}Ni_{0.5}O₂) sample showed that the pattern could also be matched to a disordered layered structure with cubic symmetry (Li_{0.17}M_{0.83})[Li_{0.83}M_{0.17}]O₂ in which approximately ⅚ (about 83%) of the M cations and approximately ⅙ (about 17%) of the Li⁺ ions resided in alternate layers of a cubic-close-packed structure, yielding an essentially identical XRD pattern to the disordered lithiated-spinel arrangement described above (FIG. 1E). (See Table 3 in Example 6 for the full results of this refinement.) The refinement of this model, using the lower symmetry space group R-3m to allow for cation disorder between the layers, yielded a c/a ratio=4.92 which, within experimental error is, for all intents and purposes, very close or equivalent to the value of 4.90 for a cubic unit cell. Such a crystallographic anomaly, i.e., a situation that deviates from what is expected or normal, would also exist between a perfectly ordered, cubic lithiated-spinel structure, such as Li₂[Co₂]O₄, and its perfectly ordered, trigonal layered counterpart, LiCoO₂, but only if the layered structure is ideally cubic close-packed (i.e., with a c/a ratio of 4.90) which, in practice, it is not (c/a=4.99), as highlighted by Rossen et al. in Solid State Ionics, Volume 62, pages 53-60 (1993).

Small variations in the exact chemical composition and symmetry of electrode materials can occur, for example, during synthesis, and through experimental error when calculating composition or determining crystallographic lattice constants and crystal symmetry with high precision which will be dependent on the quality of the materials themselves and the instrumentation used for such analyses. Thus, there may be small deviations in crystallographic composition and symmetry of the electrode materials described herein. For example, the determined lithium, transition metal/M, and/or oxygen, content of the material can vary by up to about 5 percent from an ideal 1:1:2 respective elemental stoichiometry. In electrode materials containing substituted cations or anions, such as aluminum or fluorine ions, the degree of substitution can vary by less than 2 percent when less than 10 atom percent of the transition metal ions or oxygen ions are replaced by aluminum or fluorine ions, respectively. From a crystallographic standpoint, the cubic-close-packed oxygen lattice of the disordered lithiated spinel, disordered layered and disordered rock salt components can deviate slightly from ideal cubic-close-packing as a result of localized ordering of the cations, imperfections, dislocations or cationic or anionic defects. For example, localized ordering within a disordered layered component with trigonal symmetry, R-3m, may result in slight deviations from an ideally cubic-close-packed o xygen lattice in which the crystallographic ratio of the c and a lattice parameters of the unit cell (c/a) is 4.90, by about 0.5 percent to a c/a ratio of about 4.92. Furthermore, the cubic-close-packed oxygen lattice of the disordered lithiated spinel, disordered layered and disordered rock salt components can deviate from ideal cubic-close-packing such that the crystal symmetry of one or more of the components is lowered by an anisotropic variation of at least one lattice parameter length of the unit cell by up to about 5 percent, preferably by up to about 2 percent.

With respect to the Mn:Ni ratio in some embodiments of the materials described herein, it has been found that a 1:1 ratio provides the best performing electrodes. In this case, the Mn:Ni ratio should deviate as little as possible, preferably by less than about 10 percent in the Mn or Ni content, i.e., less than a 1.1:1.0 Mn:Ni ratio. However, from a cost viewpoint, because manganese is less expensive than nickel, it could be advantageous to increase the Mn content in the Mn:Ni ratio to higher levels at the expense of lower performance, in which case the Mn:Ni ratio can vary between 2:1 and 1.1:1. As used herein in conjunction with numerical values for the ratios or proportions of elements in an empirical formula (e.g., 1:1, 2:1, or 1:1:2), the word “about” means that the specified values can vary by up to 5 percent from the stated value, which will not unduly affect the performance of the material in a lithium electrochemical cell. For example, “about 1:1 Mn to Ni” means to Mn and Ni components of the ratio can vary by up to 5%, such that the ratio of Ni to Mn can be from 1.05:1 to 0.95:1; and “about 1:1:2 Li to M to 0” means that each of the components of the ratio can vary by up to 5%, i.e., the Li and M components of the ratio can be from 1.05 to 0.95, and the O component of the ratio can be from 2.1 to 1.9.

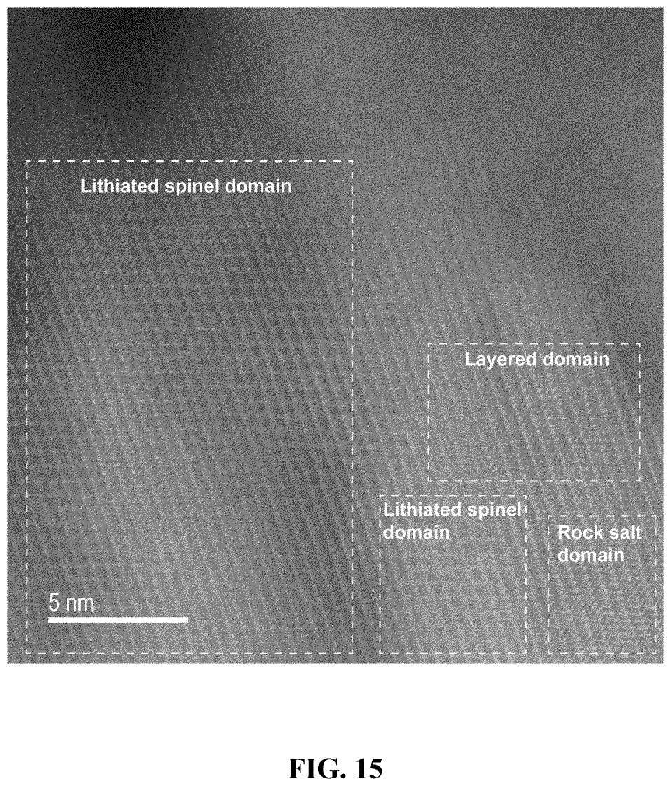

Of the two structural models described above, it is believed that a partially disordered (17%) lithiated-spinel model, (Li_{0.83}M_{0.17})_{2(16c)}[Li_{0.17}M_{0.83}]_{2(16d)}O₄₍₃₂ₑ₎, in which interconnected 3-D pathways for Li-ion transport are still likely to exist, may be the more favored structural model for LT-Li₂MnNiO₄ (LT-LiMn_{0.5}Ni_{0.5}O₂). This finds some support in the voltage profile of the Li/LT-LiMn_{0.5}Ni_{0.5}O₂ cell shown in FIG. 2, which is defined by major electrochemical processes at approximately 3.6 and 4.6 V, consistent with the difference of about 1 V that separates the reversible lithium extraction reactions from tetrahedral and octahedral sites in a LiₓMn₂O₄ (0≤x≤2) spinel electrode, respectively. Furthermore, lithium extraction from a layered HT-LiMn_{0.5}Ni_{0.5}O₂ electrode occurs at a significantly higher potential (about 3.9 V) as shown by Ohzuku and Makimura in Chemistry Letters, Volume 30, No. 8, pages 744- 745 (2001). Nevertheless, the possibility of coexistence between disordered rock salt materials, such as those containing a disordered lithiated spinel component, a disordered layered component, and a disordered rock salt component (i.e., other than a disordered lithiated spinel component and a disordered layered component) cannot be discounted. Indeed, high-resolution transmission electron microscopy (HRTEM) images of a LT-LiMn_{0.5}Ni_{0.5}O₂ sample obtained from the Environmental Molecular Sciences Laboratory at the Pacific Northwest National Laboratory have confirmed the co-existence of a lithiated-spinel component in a LiMn_{0.5}Ni_{0.5}O₂ electrode, which is structurally integrated with layered- and rock salt components in a common, shared metal oxide matrix, as demonstrated in FIG. 15. In FIG. 15, the characteristic pattern of a predominately layered structure has prominent, relatively evenly spaced rows (i.e., layers) of the transition metal ions (e.g., the rows of lighter dots in the portion labeled “disordered layered” FIG. 15). In contrast, the lithiated spinel structure has a cross-hatched appearance, while the region attributed to “disordered rock salt” has the prominent rows of a layered structure, but the rows are less distinct from the inter-row spaces.

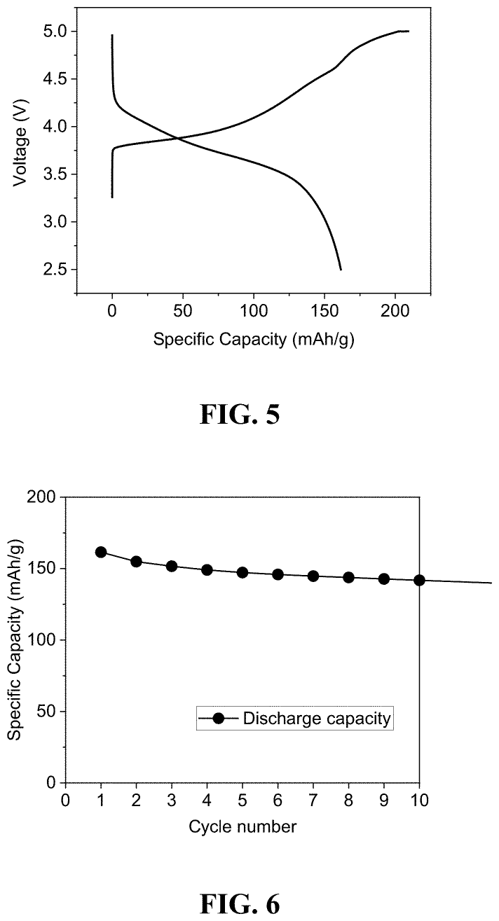

Unlike the two-plateau behavior of a Li/LT-LiMn_{0.5}Ni_{0.5}O₂ cell (FIG. 2), the voltage profile of a cell with an Al-substituted LT-LiMn_{0.45}Ni_{0.45}Al_{0.1}O₂ electrode appears to operate largely by an apparent single-phase process with a gradually sloping voltage profile at an average voltage of 3.75 V (FIG. 5). This feature is similar to that observed in a Mg-substituted electrode, LT-LiMn_{0.45}Ni_{0.45}Mg_{0.1}O₂, and in an Al-substituted LT-LiCo₁₋ₓAlₓO₂ electrode which, in the latter case, is attributed to some disorder of Al between the octahedral 16c sites and the octahedral 16c sites of a lithiated-spinel structure with space group symmetry Fd-3m, as described by Lee et al. in ACS Applied Energy Materials, Volume 2, pages 6170-6175 (2019). Such substitution in the electrode materials can therefore be used to tailor the electrochemical profile of a lithium cell.

The electrode materials described herein can include one or more disordered lithiated-spinel components, structurally integrated with one or more disordered layered components. Furthermore, because the cation-to-anion ratio in the disordered lithiated-spinel and disordered structures is about 1:1, both components can also be regarded as having partially disordered rock salt structures, such that disordered-layered- and/or disordered-rock salt components coexist with the disordered lithiated-spinel electrode components. Therefore, the LiMnₓNi_{y}M_{z}O₂ electrode materials of this invention can include one or more components comprising a partially disordered lithiated-spinel component and a partially-disordered layered component.

In an ideal, fully-ordered lithiated spinel of empirical formula Li[TM]O₂, where TM stands for transition metal, the transition metal ions and lithium ions are arranged in two different types of alternating layers in which a first layer comprises 75% TM ions and 25% Li ions, and an adjacent second layer comprises 25% TM ions and 75% lithium ions. Similarly, in a fully-ordered, layered structure of empirical formula Li[TM]O₂, the TM ions and Li ions are arranged in two different types of alternating layers in which a first layer comprises 100% TM ions, and a second adjacent layer comprises 100% Li ions. In the partially-disordered lithiated spinel and layered component structures of the material of empirical formula LiMnₓNi_{y}M_{z}O₂ described herein, a portion of the TM ions of the first layer are replaced by Li ions and a portion of the Li ions in the second layer are replaced by TM ions, leading to disorder among the ions in the different layers. Preferably, in terms of percentage, the extent of the disorder of the Mn/Ni/M cations relative to the Li cations in the alternating first and second layers ranges from 80:20 to 90:10, and more preferably from 81:19 to 85:15

Some embodiments of the electrode materials described herein constitute a structurally-integrated, lithium-metal-oxide composite electrode material of empirical formula LiM¹O₂ for an electrochemical cell wherein M¹ comprises a combination of Mn and Ni transition metal ions; the crystal structure of the material comprises domains of a disordered lithiated-spinel component, a disordered layered component, and a disordered rock salt component, in which the oxygen lattice of the components is cubic-close packed, and in which greater than 10 percent and less than 20 percent of lithium ions of the lithiated spinel and layered components are disordered among the octahedral sites normally occupied by the transition metal ions, and a corresponding percentage of the transition metal ions are disordered among the octahedral sites normally occupied by lithium ions in fully-ordered, lithiated spinel and layered structures.

In a further embodiment, any of the electrode materials described herein can be reacted further, or physically blended, with one or more other lithium metal oxide materials, e.g., cobalt-containing lithium-metal-oxide components, such as layered or lithiated-spinel LiCoO₂ or substituted components such as LT-LiCo₁₋ₓAlₓO₂ reported by Lee et al. in ACS Applied Energy Materials, Volume 2, pages 6170-6175 (2019) to form either two-component- or multi-component electrode structurally integrated materials that contain the lithiated-spinel LiMnₓNi_{y}M_{z}O₂ materials described herein. Ideally, the cobalt content in these ‘mixed’ electrodes should be as low as possible, preferably close to zero, when it is possible that some Co may be incorporated within the lithiated-spinel structure. A specific embodiment, therefore, includes lithiated-spinel LiMnₓNi_{y}M_{z}O₂ materials in which M can be Co with z at most 0.2 for x+y+z=1, and preferably less than, or equal to z=0.1, or most preferably, less than or equal to 0.05 to keep the Co content as low as possible.

The electrode materials described herein can include surface treatments and coatings to protect the surface of the electrode particles from undesirable reactions with the electrolyte, for example, by treating or coating the electrode particles with layers of metal-oxide, metal-fluoride or metal-phosphate materials to shield and protect the electrodes from highly oxidizing charging potentials and from other undesirable effects, such as electrolyte oxidation, oxygen loss, and/or dissolution. Such surface protection enhances the surface stability, rate capability and cycling stability of the electrode materials. In some embodiments the lithiated-spinel LiCo₁₋ₓAlₓO₂ (0<x<0.5) materials, described by Lee et al. in ACS Applied Energy Materials, Volume 2, pages 6170-6175 (2019), may be used as protective layers or coatings for the lithiated-spinel LiMnₓNi_{y}M_{z}O₂ electrode materials described herein, particularly when formed by grinding or ball milling the electrode materials with lithiated-spinel LiCo₁₋ₓAlₓO₂ (0<x<0.5) compounds. Conversely, the lithiated-spinel LiMnₓNi_{y}M_{z}O₂ electrode materials described herein can be used as protective coatings for other underlying lithium-metal-oxide electrode materials, such as layered Li-Ni-Mn-O and Li-Mn-Ni-Co-O (NMC) electrode materials and spinel Li-Mn-O (LMO) electrode materials and substituted and compositional variations of these materials.

Non-limiting examples of cobalt-free, lithiated-spinel materials described herein are provided in Table 1, Section (a). Section (b) of Table 1 provides non-limiting examples of compositions comprising at least one cobalt-free lithiated spinel as described herein in combination with (e.g., structurally integrated with, or mixed with) at least one cobalt-containing component.

TABLE 1
Lithiated-spinel LiMnₓNi_{y}M_{z}O₂ electrode compositions (M = one
or more metal cations excluding M = Mn, Ni, Co)

| | | |
|---|---|---|
| | Molecular | Theoretical Capacity |
| Electrode Composition | Mass | (mAh/g) (Amount |
| (net) | (g) | of Li extracted) |

a) Co-free compositions

| | | |
|---|---|---|
| LiMn_{0.50}Ni_{0.50}O₂ | 95.754 | 280.01 (1.0 Li) |
| LiMn_{0.45}Ni_{0.45}Al_{0.10}O₂ | 92.771 | 260.11 (0.9 Li) |
| LiMn_{0.40}Ni_{0.40}Al_{0.20}O₂ | 89.770 | 238.94 (0.8 Li) |
| LiMn_{0.35}Ni_{0.35}Al_{0.30}O₂ | 83.821 | 191.92 (0.6 Li) |
| LiMn_{0.4}Ni_{0.4}Ti_{0.1}Mg_{0.1}O₂ | 91.609 | 234.14 (0.8 Li) |

b) Multi-component compositions comprising one or more
lithiated-spinel LiMnₓNi_{y}M_{z}O₂ component and one
or more Co-containing component

| | | |
|---|---|---|
| LiMn_{0.45}Ni_{0.45}Al_{0.05}Co_{0.05}O₂ | 94.369 | 269.91 (0.95 Li) |
| LiMn_{0.40}Ni_{0.40}Al_{0.10}Co_{0.10}O₂ | 92.983 | 259.52 (0.90 Li) |
| LiMn_{0.45}Ni_{0.45}Co_{0.10}O₂ | 95.966 | 279.39 (1.00 Li) |

As used herein the term “lithium battery” refers to electrochemical cells and combinations of electrochemical cells in which lithium (e.g., lithium ion) shuttles between a Si anode and a cathode, and includes so-called full cells, as well as so-called half-cells (e.g. comprising a lithium metal anode).

Electrodes for lithium electrochemical cells typically are formed by coating a slurry of electrode active material in a solvent with a polymeric binder (e.g., poly(vinylidene difluoride); PVDF) onto a current collector (e.g., metal foil, conductive carbon fiber paper, and the like), and drying the coating to form the electrode. Some examples of electrode active materials can be found, e.g., in Mekonnen, Y., Sundararajan, A. & Sarwat, A. I. “A review of cathode and anode materials for lithium-ion batteries,” SoutheastCon 2016, Norfolk, Va., pp. 1-6, (2016), which is incorporated herein by reference in its entirety.

The electrodes utilize binders (e.g., polymeric binders) to aid in adhering cathode active materials to the current collectors. In some cases, the binder comprises a poly(carboxylic acid) or a salt thereof (e.g., a lithium salt), which can be any poly(carboxylic acid), such as poly(acrylic acid) (PAA), poly(methacrylic acid), alginic acid, carboxymethylcellulose (CMC), poly(aspartic acid) (PAsp), poly(glutamic acid) (PGlu), copolymers comprising poly(acrylic acid) chains, poly(4-vinylbenzoic acid) (PV4BA), and the like, which is soluble in the electrode slurry solvent system. The poly(carboxylic acid) can have a Mₙ, as determined by GPC, in the range of about 1000 to about 450,000 Daltons (preferably about 50,000 to about 450,000 Daltons, e.g., about 130,000 Daltons). In some other embodiments, the binder may comprise anionic materials or neutral materials such as fluorinated polymer such as poly(vinylidene difluoride) (PVDF), carboxymethylcellulose (CMC), and the like.

Lithium-ion electrochemical cells described herein comprise a cathode (positive electrode), an anode (negative electrode), and an ion-conductive separator between the cathode and anode, with the electrolyte in contact with both the anode and cathode, as is well known in the battery art. It is well understood that the function of a given electrode switches from being a positive or negative electrode depending on whether the electrochemical cell is discharging or charging. Nonetheless, for the sake of convenient identification, the terms “cathode” and “anode” as used herein are applied as identifiers for a particular electrode based only on its function during discharge of the electrochemical cell.

Cathodes typically are formed by combining a powdered mixture of the active material and some form of carbon (e.g., carbon black, graphite, or activated carbon) with a binder such as (polyvinylidene difluoride (PVDF), carboxymethylcellulose, and the like) in a solvent (e.g., N-methylpyrrolidone (NMP) or water) and the resulting mixture is coated on a conductive current collector (e.g., aluminum foil) and dried to remove solvent and form an active layer on the current collector.

The anode comprises a material capable of reversibly releasing and accepting lithium during discharging and charging of the electrochemical cell, respectively. Typically, the anode comprises a carbon material such as graphite, graphene, carbon nanotubes, carbon nanofibers, and the like, a silicon-based material such as silicon metal particles, a lead-based material such as metallic lead, a nitride, a silicide, a phosphide, an alloy, an intermetallic compound, a transition metal oxide, and the like. The anode active components typically are mixed with a binder such as (polyvinylidene difluoride (PVDF), carboxymethyl cellulose, and the like) in a solvent (e.g., NMP or water) and the resulting mixture is coated on a conductive current collector (e.g., copper foil) and dried to remove solvent and form an active layer on the current collector.

In some embodiments the anode comprises silicon-containing particles, preferably combined with carbon particles. The silicon-containing particles can be silicon nanoparticles, silicon/silicon oxide (Si/SiOx) nanocomposite particles, silicon nanotubes, microporous silicon, an alloy or intermetallic compound of silicon with a metal such as magnesium, calcium, nickel, iron, or cobalt. Some examples of useful silicon-containing materials are discussed in Ma et al., Nano-Micro Lett., 2014, 6(4):347-358, which is incorporated herein by reference in its entirety. Some other examples are mentioned in Zhu et al., Chemical Science, 2019 10, 7132., which is incorporated herein by reference in its entirety. Si/SiOx nanocomposite particles include e.g., materials described in co-owned, co-pending application Ser. No. 15/663,268 to Wenquan Lu et al., filed on Jul. 28, 2017 which is incorporated herein by reference in its entirety.

Preferably, the silicon-containing particles, when utilized in the anode, have an average size in the range of about 50 to about 200 nm, more preferably about 70 to about 150 nm. The carbon particles can be carbon microparticles or nanoparticles. Non-limiting examples of carbon materials include, e.g., carbon black, graphite, carbon nanotubes, carbon nanofibers, and graphene. Preferably, the electrode includes silicon and carbon particles in a respective weight ratio (Si:C) of about 1:9 to about 9:1, more preferably about 1:5 to about 8:1. The binder typically comprises about 5 to about 30 percent by weight (wt%), preferably about 10 to about 20 wt %, of the active material coated on the current collector, based on the combined weight of the silicon, carbon and binder in the finished electrode (i.e., after drying). The loading of silicon and carbon particles and binder on the current collector typically is in the range of about 0.6 to about 3.2 mg/cm², preferably about 0.8 to about 2.7 mg/cm².

As used herein, the terms “structurally-integrated” and “structurally-integrated composite” when used in relation to a lithium metal oxide a material refers to materials that include domains (e.g., locally ordered, nano-sized or micro-sized domains) indicative of different metal oxide compositions having different crystalline forms (e.g., layered or spinel forms) within a single particle of the composite metal oxide, in which the domains share substantially the same oxygen lattice and differ from each other by the elemental and spatial distribution of metal ions in the overall metal oxide structure. Structurally-integrated composite lithium metal oxides are different from and generally have different properties than mere mixtures or combinations of two or more metal oxide components (for example, mere mixtures do not share a common oxygen lattice).

In electrochemical cell and battery embodiments described herein, the electrolyte comprises an electrolyte salt (e.g., an electrochemically stable lithium salt or a sodium salt) dissolved in a non-aqueous solvent. Any lithium electrolyte salt can be utilized in the electrolyte compositions for lithium electrochemical cells and batteries described herein, such as the salts described in Jow et al. (Eds.), Electrolytes for Lithium and Lithium-ion Batteries; Chapter 1, pp. 1-92; Springer; New York, N.Y. (2014), which is incorporated herein by reference in its entirety.

Non-limiting examples of lithium salts include, e.g., lithium bis(trifluoromethanesulfonyl)imidate (LiTF SI), lithium 2-trifluoromethyl-4,5-dicyanoimidazolate (LiTDI), lithium 4,5-dicyano-1,2,3-triazolate (LiDCTA), lithium trifluoromethanesulfonate (LiTf), lithium perchlorate (LiClO₄), lithium bis(oxalato)borate (LiB(C₂O₄)₂ or “LiBOB”), lithium difluoro(oxalato)borate (LiF₂BC₂O₄ or “LiDFOB”), lithium tetrafluoroborate (LiBF₄), lithium hexafluorophosphate (LiPF₆), lithium hexafluoroarsenate (LiAsF₆), lithium thiocyanate (LiSCN), lithium bis(fluorosulfonyl)imidate (LiFSI), lithium bis(pentafluoroethylsulfonyl)imidate (LiBETI), lithium tetracyanoborate (LiB(CN)₄), lithium nitrate, combinations of two or more thereof, and the like. The lithium salt can be present in the electrolyte solvent at any concentration suitable for lithium battery applications, which concentrations are well known in the secondary battery art. As used herein the term “lithium battery” refers to electrochemical cells and combinations of electrochemical cells in which lithium (e.g., lithium ion) shuttles between an anode and a cathode, and includes so-called full cells with an anode material (e.g., graphite) that can accommodate intercalated lithium ions, as well as so-called half-cells in which the anode is lithium metal. In some embodiments, the lithium salt is present in the electrolyte at a concentration in the range of about 0.1 M to about 5 M, e.g., about 0.5 M to 2 M, or 1 M to 1.5 M. A preferred lithium salt is LiPF₆.

The non-aqueous solvent for the electrolyte compositions include the solvents described in Jow et al. (Eds.), Electrolytes for Lithium and Lithium-ion Batteries; Chapter 2, pp. 93-166; Springer; New York, N.Y. (2014), which is incorporated herein by reference in its entirety. Non-limiting examples of solvents for use in the electrolytes include, e.g., an ether, a carbonate ester (e.g., a dialkyl carbonate or a cyclic alkylene carbonate), a nitrile, a sulfoxide, a sulfone, a fluoro-substituted linear dialkyl carbonate, a fluoro-substituted cyclic alkylene carbonate, a fluoro-substituted sulfolane, and a fluoro-substituted sulfone. For example, the solvent can comprise an ether (e.g., glyme or diglyme), a linear dialkyl carbonate (e.g., dimethyl carbonate (DMC), diethyl carbonate (DEC), ethyl methyl carbonate (EMC) and the like), a cyclic alkylene carbonate (ethylene carbonate (EC), propylene carbonate (PC) and the like), a sulfolane (e.g., sulfolane or an alkyl-substituted sulfolane), a sulfone (e.g., a dialkyl sulfone such as a methyl ethyl sulfone), a fluoro-substituted linear dialkyl carbonate, a fluoro-substituted cyclic alkylene carbonate, a fluoro-substituted sulfolane, and a fluoro-substituted sulfone. The solvent can comprise a single solvent compound or a mixture of two or more solvent compounds.

In some embodiments, the non-aqueous solvent for a lithium electrochemical cell as described herein can be an ionic liquid. Any electrochemically stable ionic liquid solvent can be utilized in the electrolytes described herein, such as the solvents described in Jow et al. (Eds.), Electrolytes for Lithium and Lithium-ion Batteries; Chapter 4, pp. 209-226; Springer; New York, N.Y. (2014), which is incorporated herein by reference in its entirety. In the case of lithium electrochemical cells and batteries, the ionic liquid can optionally include a lithium cation, and can act directly as the electrolyte salt.

The electrolyte compositions for lithium electrochemical cells and batteries described herein also can optionally comprise an additive such as those described in Jow et al. (Eds.), Electrolytes for Lithium and Lithium-ion Batteries; Chapter 3, pp. 167-182; Springer; New York, N.Y. (2014), which is incorporated herein by reference in its entirety. Such additives can provide, e.g., benefits such as SEI, cathode protection, electrolyte salt stabilization, thermal stability, safety enhancement, overpotential protection, corrosion inhibition, and the like. The additive can be present in the electrolyte at any concentration, but in some embodiments is present at a concentration in the range of about 0.0001 M to about 0.5 M. In some embodiments, the additive is present in the electrolyte at a concentration in the range of about 0.001 M to about 0.25 M, or about 0.01 M to about 0.1 M.

Electrochemical cells typically comprise a cathode, an anode typically comprising carbon, silicon, lead, metallic lithium, some other anode active material, or a combination thereof; and a porous separator between the cathode and anode, with the electrolyte in contact with the anode, the cathode and the separator.

A battery can be formed by electrically connecting two or more such electrochemical cells in series, parallel, or a combination of series and parallel. The electrodes described herein preferably are utilized as the anode in a full-cell configuration in lithium-ion and sodium-ion cells and batteries. Electrochemical cells and battery designs and configurations, anode and cathode materials, as well as electrolyte salts, solvents and other battery or electrode components (e.g., separator membranes, current collectors), which can be used in the electrolytes, cells and batteries described herein, are well known in the secondary battery art, e.g., as described in “Lithium Batteries Science and Technology” Gholam-Abbas Nazri and Gianfranco Pistoia, Eds., Springer Science+Business Media, LLC; New York, N.Y. (2009), which is incorporated herein by reference in its entirety.

The separator component of the lithium-ion cell can be any separator used in the lithium battery art. A typical material is a porous polyalkylene material such as microporous polypropylene, microporous polyethylene, a microporous propylene-ethylene copolymer, or a combination thereof, e.g., a separator with layers of different polyalkylenes; a poly(vinylidene-difluoride)-polyacrylonitrile graft copolymer microporous separator; and the like. Examples of suitable separators are described in Arora et al., Chem. Rev. 2004, 104, 4419-4462, which is incorporated herein by reference in its entirety. In addition, the separator can be an ion-selective ceramic membrane such as those described in Nestler et al., AIP Conference Proceedings 1597, 155 (2014), which is incorporated herein by reference in its entirety.

Processes used for manufacturing lithium cells and batteries are well known in the art. The active electrode materials are coated on both sides of metal foil current collectors (typically copper for the anode and aluminum for the cathode) with suitable binders such as PVDF and the like to aid in adhering the active materials to the current collectors. In the cells and batteries described herein, the active cathodes are the lithiated-spinel materials, LiMnₓNi_{y}M_{z}O₂, defined herein, which optionally can be utilized with a carbon material such as graphite, and the anode active material typically is a lithium metal, carbon, and the like. Cell assembly typically is carried out on automated equipment. The first stage in the assembly process is to sandwich a separator between the anode and the cathode. The cells can be constructed in a stacked structure for use in prismatic cells, or a spiral wound structure for use in cylindrical cells. The electrodes are connected to terminals and the resulting sub-assembly is inserted into a casing, which is then sealed, leaving an opening for filling the electrolyte into the cell. Next, the cell is filled with the electrolyte and sealed under moisture-free conditions.

Once the cell assembly is completed, the cell typically is subjected to at least one controlled charge/discharge cycle to activate the electrode materials and in some cases form a solid electrolyte interface (SEI) layer on the anode. This is known as formation cycling. The formation cycling process is well known in the battery art and involves initially charging with a low voltage (e.g., substantially lower that the full-cell voltage) and gradually building up the voltage. The SEI acts as a passivating layer which is essential for moderating the charging process under normal use. The formation cycling can be carried out, for example, according to the procedure described in Long et al. J. Electrochem. Soc., 2016; 163 (14): A2999-A3009, which is incorporated herein by reference in its entirety. This procedure involves a 1.5 V tap charge for 15 minutes at C/3 current limit, followed by a 6-hour rest period, and then 4 cycles at C/10 current limit, with a current cutoff (i≤0.05 C) at the top of each charge.

Cathodes comprising the cobalt free lithiated spinel materials described herein can be utilized with any combination of anode and electrolyte in any type of rechargeable battery system that utilizes a non-aqueous electrolyte.

The following general methodology and non-limiting Examples are provided to illustrate certain features of the compositions and methods described herein.

### Methodology 1. Synthesis of LiMnₓNi_{y}M_{z}O₂ (M=Al) Materials

A parent, unsubstituted LiMn_{0.5}Ni_{0.5}O₂ electrode material (x=0.5; y=0) is prepared by a ‘low-temperature’ method reported previously by Gummow et al. in Mat. Res. Bull. 27, 327 (1992), and U.S. Pat. No. 5,160,712. Cation substituted materials of formula LiMnₓNi_{y}Al_{z}O₂, for x=0.45, 0.35, 0.30; y=0.45, 0.35, 0,30; and z=0.1, 0.2, 0.3, respectively, as listed in Table 1, are prepared by solid-state reaction of lithium carbonate (Li₂CO₃, >99%), manganese hydroxide, nickel hydroxide, and aluminum nitrate (Al(NO₃)₃•9H₂O, >99%) precursors. Alternatively, mixed-metal precursors, such as manganese-nickel hydroxide, or metal oxide precursors, such as manganese dioxide, can be used. Stoichiometric amounts of the precursors are thoroughly mixed using a mortar and pestle, and fired in air at 400° C. in a furnace for approximately 6 days. The heating rate is about 2° C. per min. The samples are cooled in the furnace without controlling the cooling rate. Samples can also be prepared in air at higher temperature, i.e., at 450, 500, 550 and 600° C. to increase the layered character of the LiMn_{0.5}Ni_{0.5}O₂ and LiMnₓNi_{y}Al_{z}O₂ electrode structures.

It should be noted that for materials in which the Mn:Ni ratio is 1:1, and in which the manganese and nickel ions are tetravalent and divalent, respectively, for example LiMn_{0.45}Ni_{0.45}Al_{0.10}O₂, the full electrochemical capacity of the electrode (260 mAh/g, Table 1) would, in principle, be associated with the oxidation of Ni²⁺ to Ni⁴⁺ and the extraction of 0.9 Li⁺ ions from an electrode structure in which only 45% of the non-lithium metal ions (Mn, Ni, Al) is nickel. It is anticipated that such an electrode composition would have significant cost and safety advantages over their nickel-rich NMC counterparts, for example, LiNi_{0.8}Mn_{0.1}Co_{0.1}O₂ (‘811’) and LiNi_{0.6}Mn_{0.2}Co_{0.2}O₂ (‘622’) in lithium-ion cells. In addition, nearest neighbor Mn-Ni interactions may assist electronic conductivity of these lithiated-spinel-related electrodes during electrochemical operation.

### Methodology 2. Synthesis of Two-Component Materials Comprising a LiMnₓNi_{y}Al_{z}O₂ Component and a Cobalt-Containing Lithium-Metal-Oxide Component

The materials of Example 1 are combined with a LT-LiCoO₂ lithiated-spinel product that is prepared at 400° C. as described by Lee et al. in ACS Applied Energy Materials, Volume 2, pages 6170-6175 (2019), either by mechanical blending, for example, by high-energy ball milling at room temperature, or by reaction in air at temperatures between 400 and 600° C. to yield composite electrode structures with two or more lithium-metal-oxide components that can be integrated structures or blended mixtures having either lithiated-spinel character or a combination of lithiated-spinel and layered character, and disordered structural variations thereof

### Methodology 3. Synthesis of LT-LiM¹O₂ Materials Using Flame Spray Pyrolysis (FSP) and Low Temperature Sintering

A precursor solution is prepared by dissolving stoichiometric amounts of a nickel salt (e.g., nickel acetylacetonate), a cobalt salt (e.g., cobalt acetylacetonate), a manganese salt (e.g., manganese acetylacetonate) in the required Ni:Co:Mn_ratio for a target LT-LiM¹O₂ composition (where M¹ comprises Ni, Mn and Co, e.g., LT-NMC111 where Ni:Co:Mn is 1:1:1) and a small excess of a lithium salt (e.g., lithium propionate) to compensate for lithium loss in the flame, in a solvent. Typically, about 1 to about 10% excess lithium salt, and preferably less than 10% excess lithium salt, are dissolved in an appropriate solvent (i.e., a solvent capable of dissolving the salts, such as water, or an organic solvent (e.g., a polar organic solvent) a C1 to C6 alcohol (e.g., methanol ethanol, or propanol, isopropanol), a nitrile such as acetonitrile or propionitrile and the like, an amide such as N,N-dimethylformamide, acetamide, and the like), a C1 to C10 organic acid, such as formic acid, acetic acid, propionic acid, hexanoic acid, 2-ethylhexanoic acid, and the like., or a combination of two or more such solvents. A preferred solvent is acetonitrile and 2-ethylhexanoic acid (5:5 by volume) at a concentration of 0.31 mol/L. The precursor solution is then atomized with oxygen to form liquid droplets, which are sprayed into the methane/oxygen pilot flame of a FSP unit, thereby vaporizing and oxidizing the metal salts to form a precursor powder comprising the requisite ratio of transition metal ions to lithium ion for the target composition. The resulting powder is subsequently sintered at a temperature in the range of about 400 to about 650° C. in air for about 3 to about 5 days. In some embodiments, the transition metal and lithium salts comprise organic acid anions such as, e.g., acetate, propionate, acetylacetonate, and the like. Some preferred solvents suitable for use with the FSP method include polar organic solvents such as acetonitrile, 2-ethylhexanoic acid, or a combination of thereof

### Methodology 4. Electrochemical Evaluations

Coin-type cells (2032, Hohsen) are constructed in an argon-filled glovebox (<5 ppm O₂ and H₂O). The cathode consists of approximately 84 percent by weight (wt%) of LiMnₓNi_{y}M_{z}O₂ powder (M=Al), 8 wt % carbon, and 8 wt% PVDF binder on aluminum foil. The anode is metallic lithium foil or an alternative host electrode for lithium, such as graphite or Li₄Ti₅O₁₂. The electrolyte is typically 1.2 M LiPF₆ in a 3:7 (w/w) mixture of ethylene carbonate and ethyl-methyl carbonate. For the cycling experiments, Li/LiMnₓNi_{y}M_{z}O₂ cells (M=Al) are galvanostatically charged and discharged between 2.5 and 4.2 V at a current rate of either approximately 15 mA/g or approximately 60 mA/g. The electrochemical experiments are conducted at approximately 30° C.

### Example 1—LT-LiMn_{0.5}Ni_{0.5}O₂

LT-LiMn_{0.5}Ni_{0.5}O₂ was prepared as follows:

A Mn_{0.5}Ni_{0.5}(OH)₂ precursor was first prepared by a co-precipitation reaction in an aqueous solution containing manganese sulfate (MnSO₄) and nickel sulfate (NiSO₄). A LT-LiMn_{0.5}Ni_{0.5}O₂ electrode material was synthesized by a ‘low-temperature’ solid-state reaction of the Mn_{0.5}Ni_{0.5}(OH)₂ precursor and lithium carbonate (Li₂CO₃, >99%). Stoichiometric amounts of the precursors were thoroughly mixed using a mortar and pestle, and fired in air at 400° C. for approximately 72 hours. The heating rate was about 2° C. per min, and the samples were cooled in the furnace without controlling the cooling rate. The X-ray diffraction (XRD) pattern (Cu Kα radiation, λ=1.5406 Å) of LT-LiMn_{0.5}Ni_{0.5}O₂ is shown in FIG. 1.

Li/LT-LiMn_{0.5}Ni_{0.5}O₂ cells were assembled and evaluated as follows: Coin-type cells (2032, Hohsen) were assembled in an argon-filled glovebox (<5 ppm O₂ and H₂O) for electrochemical tests. The cathode electrode consisted of approximately 84 wt % of LT-LiMn_{0.5}Ni_{0.5}O₂ powder, 8 wt % carbon, and 8 wt % polyvinylidene difluoride (PVDF) binder on an aluminum foil current collector. The anode was metallic lithium foil. The electrolyte was 1.2 M lithium hexafluorophosphate (LiPF₆) in a 3:7 mixture of ethylene carbonate and ethyl methyl carbonate. The coin cell was galvanostatically charged and discharged between 2.5 and 5.0 V at a constant current of approximately 15 mA/g. Electrochemical experiments were conducted at about 30° C. Voltage (V) vs. specific capacity (mAh/g) plots of a Li/LT-LiMn_{0.5}Ni_{0.5}O₂ cell cycled between 5.0 and 2.5 V for the first 20 cycles are shown in FIG. 2.

Ex situ synchrotron XRD patterns collected at different states of charge (SOC) showed that the LT-Li₂MnNiO₄ electrode structure maintains its cubic symmetry during the entire charge/discharge cycle and that the overall lattice volume change of 2.7% during cycling is significantly less than it is for the well-known spinels LiₓMn₂O₄ (16%) and LiₓMn_{1.5}Ni_{0.5}O₄ (12%) when discharged to about 2.5 V (0≤x≤2).

### Example 2—LT-LiMn_{0.5}Ni_{0.5}O₂

LT-LiMn_{0.5}Ni_{0.5}O₂ was prepared as described in Example 1.

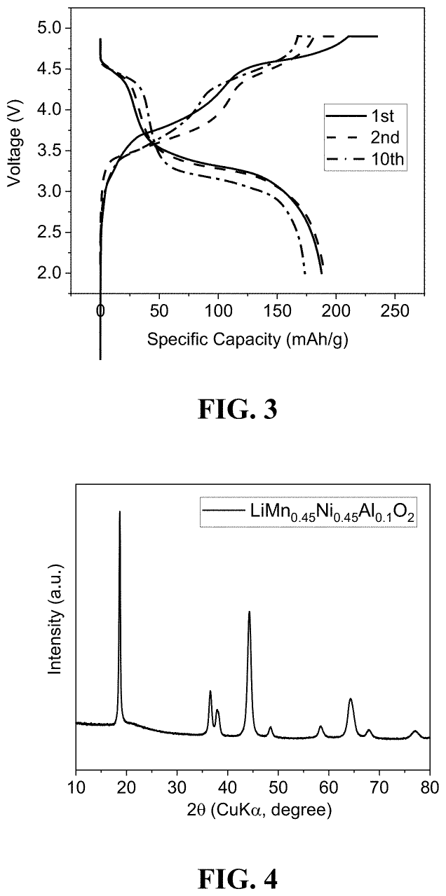

Graphite/LT-LiMn_{0.5}Ni_{0.5}O₂ cells were assembled following a similar procedure as described in Example 1, except that a graphite anode was used instead of metallic Li, and were evaluated as follows: Anode laminates were prepared by coating a graphite slurry on copper foil. The composition of the graphite slurry was 91.83 wt % graphite powder, 2 wt % carbon black, 6 wt % PVDF binder, and 0.17% oxalic acid. Coin cells were cycled between 2.0 to 4.9 Vat a constant current of 100 mA/g. Voltage (V) vs. specific capacity (mAh/g) plots of a graphite/LT-LiMn_{0.5}Ni_{0.5}O₂ cell cycled between 4.9 and 2.0 V for the first 10 cycles are shown in FIG. 3.

### Example 3—LT-LiMn_{0.45}Ni_{0.45}Al_{0.1}O₂

LT-LiMn_{0.45}Ni_{0.45}Al_{0.1}O₂ was prepared as follows: The LT-LiMn_{0.45}Ni_{0.45}Al_{0.1}O₂ powder was prepared following a similar procedure described in Example 1. Stoichiometric amounts of Li₂CO₃, Mn_{0.5}Ni_{0.5}(OH)₂, and aluminum nitrate nonahydrate (Al(NO₃)₃•9H₂O, >98%) precursors were thoroughly mixed with a planetary ball mill (RESTCH PM 200). The mixed powder was pressed into a pellet and fired in air at 400° C. for approximately 72 hours. The XRD pattern (Cu Kα radiation, λ=1.5406 Å) of the LT-LiMn_{0.45}Ni_{0.45}Al_{0.1}O₂ product is shown in FIG. 4.

Li/LT-LiMn_{0.45}Ni_{0.45}Al_{0.1}O₂ cells with a metallic Li anode were assembled and evaluated as described in Example 1. The initial voltage (V) vs. specific capacity (mAh/g) plot of a Li/LT-LiMn_{0.45}Ni_{0.45}Al_{0.1}O₂ cell cycled between 5.0 and 2.5 V is shown in FIG. 5. Specific capacity vs. cycle number plots for this cell, cycled between 5.0 and 2.5 V for the first 10 cycles, are shown in FIG. 6.

Of particular note is that the voltage profile of the cell in which Al is used as a minor substituent in the LT-LiMn_{0.45}Ni_{0.45}Al_{0.1}O₂ electrode (FIG. 5) does not show the pronounced two-step process during charge and discharge, similar to that observed in cells containing the parent lithiated-spinel electrode LT-LiMn_{0.5}Ni_{0.5}O₂ (FIG. 2). However, this feature is similar to that observed in a Mg-substituted electrode, LT-LiMn_{0.45}Ni_{0.45}Mg_{0.1}O₂, and also in a reference Al-substituted LT-LiCo₁₋ₓAlₓO₂ electrode, which is attributed to some disorder of Al between the octahedral 16c sites and the octahedral 16c sites of a lithiated-spinel structure with space group symmetry Fd3̅m, as described by Lee et al. in ACS Applied Energy Materials, Volume 2, pages 6170-6175 (2019).

### Example 4—Physical Blend: LT-LiMn_{0.5}Ni_{0.5}O₂ (90%)+10 wt % LT-LiCo_{0.75}Al_{0.25}O₂

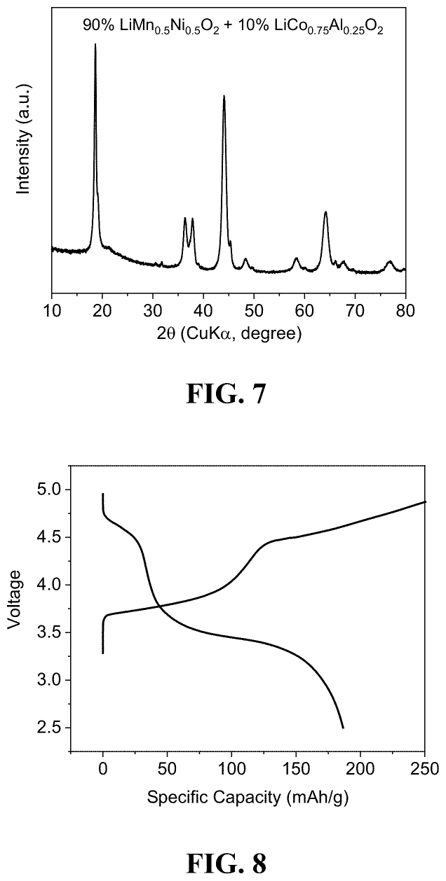

LT-LiMn_{0.5}Ni_{0.5}O₂ was prepared by the method described in Example 1. LT-LiCo_{0.75}Al_{0.25}O₂ was prepared as follows: Stoichiometric amounts of Li₂CO₃, CoCO₃, and Al(NO₃)₃•₉H₂O were thoroughly mixed using a mortar and pestle. The mixture was then fired in air at 400° C. for 6 days. A blended electrode material was prepared by mechanically grinding the LT-LiMn_{0.5}Ni_{0.5}O₂ and LT-LiCo_{0.75}Al_{0.25}O₂ powders in a 90:10 percent ratio by mass using a mortar and pestle. The XRD pattern (Cu Kα radiation, λ=1.5406 Å) of a LT-LiMn_{0.5}Ni_{0.5}O₂+LT-LiCo_{0.75}Al_{0.25}O₂ electrode powder, blended in a 90:10 percent ratio by mass, respectively, is shown in FIG. 7.

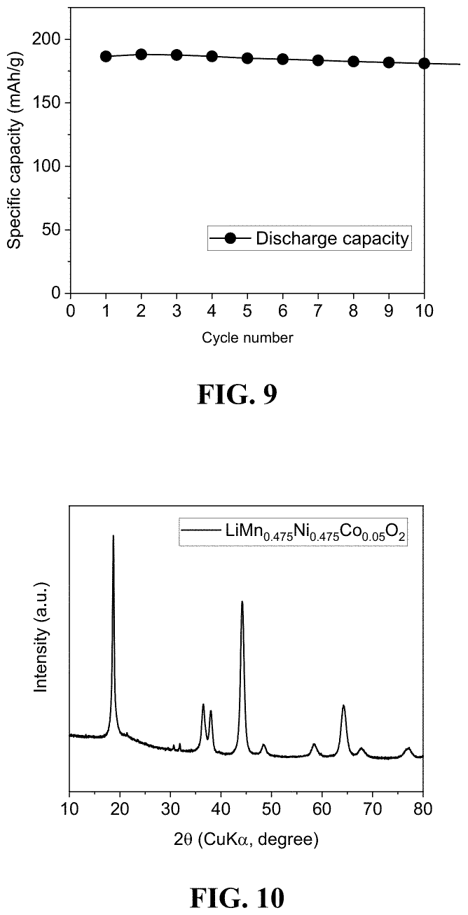

Li/LT-LiMn_{0.45}Ni_{0.45}Al_{0.1}O₂ cells with a metallic Li anode were assembled and evaluated as described in Example 1. The electrochemical profile of the initial charge and discharge of a Li/LT-LiMn_{0.5}Ni_{0.5}O₂+LT-LiCo_{0.75}Al_{0.25}O₂ cell when activated to 5.0 V and discharged to 2.5 V as a function of voltage (V) and specific capacity (mAh/g) is shown in FIG. 8. Corresponding specific capacity vs. cycle number plots of this Li/LT-LiMn_{0.5}Ni_{0.5}O₂+LT-LiCo_{0.75}Al_{0.25}O₂ cell cycled between 5.0 and 2.5 V for the first 10 cycles is shown in FIG. 9.

### Example 5—LT-LiMn_{0.47}Ni_{0.475}Co_{0.05}O₂

LT-LiMn_{0.475}Ni_{0.475}Co_{0.05}O₂ powder was prepared following a similar procedure to that described in Example 1. Stoichiometric amounts of Li₂CO₃ and Mn_{0.475}Ni_{0.475}Co_{0.05}(OH)₂ precursors were thoroughly mixed using a mortar and pestle and fired in air at 400° C. for approximately 72 hours. The XRD pattern (Cu Kα radiation, λ=1.5406 Å) of LT-LiMn_{0.475}Ni_{0.475}Co_{0.05}O₂ is shown in FIG. 10.

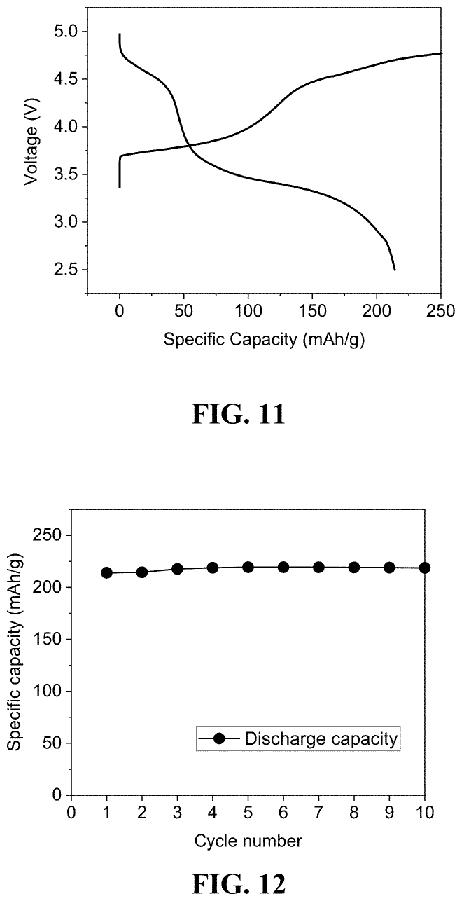

LT-LiMn_{0.475}Ni_{0.475}Co_{0.05}O₂ cells were assembled and evaluated as in Example 1. The electrochemical profile of the initial charge and discharge of a Li/LT-LiMn_{0.475}Ni_{0.475}Co_{0.05}O₂ cell when activated to 5 V and discharged to 2.5 V as a function of voltage (V) and specific capacity (mAh/g) is shown in FIG. 11. Corresponding voltage (V) vs. specific capacity (mAh/g) plots of this cell, when cycled between 5.0 and 2.5 V for the first 10 cycles is shown in FIG. 12.

In the above examples, the upper cut-off voltage was 5.0 V for the cells with a Li anode, and 4.9 V for the cell with a graphite anode. This high voltage was selected to maximize capacity and assess the stability of the electrode materials. In practice, it is anticipated that greater cycling stability of the cells will be achieved by lowering the upper cut-off voltage, for example to 4.75 V or lower, albeit with lower capacity. In this respect, improvements in the electrochemical properties of the electrode materials described herein can be expected by tailoring their synthesis and the voltage window of the cells during electrochemical cycling to achieve optimum cell performance.

### Example 6—Structural and Electrochemical Analyses of LT-LiMn_{0.5}Ni_{0.5}O₂

### Structure Analysis

Structural refinements of a LT-LiMn_{0.5}Ni_{0.5}O₂ sample, prepared by the method described in Example 1, were undertaken to determine the structure-type and the extent of disorder, if any, between the lithium, manganese, and nickel ions in the structure. For these studies, high quality synchrotron X-ray diffraction data (λ=0.1173 Å) were collected at the Advanced Photon Source at Argonne National Laboratory (FIG. 1C). It was discovered, very surprisingly, that a remarkably good fit to the data was obtained with either a disordered, lithiated-spinel model structure (FIG. 1D) or a disordered, layered model structure (FIG. 1E), as highlighted by the refined parameters and goodness-of-fit factors, R=8.56 and R=8.80 in Tables 2 and 3, respectively, making it extremely difficult, or impossible, to determine, unequivocally, the precise structure type, or whether both structure types were present in the sample.

TABLE 2
Refined crystallographic parameters of a disordered lithiated-spinel structural
model with cubic symmetry for LT-Li₂MnNiO₄.
Space group: Fd-3m, a = 8.217 Å, R_{wp} = 8.56%

| Atom | Site | x | y | z | Occ | B_{eq} |
|---|---|---|---|---|---|---|
| Li1 | 16c | 0 | 0 | 0 | 0.834 | 1 |
| Li2 | 16d | 0.5 | 0.5 | 0.5 | 0.166 | 1 |
| Mn1 | 16c | 0 | 0 | 0 | 0.083 | 1 |
| Mn2 | 16d | 0.5 | 0.5 | 0.5 | 0.417 | 1 |
| Ni1 | 16c | 0 | 0 | 0 | 0.083 | 1 |
| Ni2 | 16d | 0.5 | 0.5 | 0.5 | 0.417 | 1 |
| O | 32e | 0.258 | 0.258 | 0.258 | 1 | 1.691 |

TABLE 3
Refined crystallographic parameters of a disordered layered
structural model with cubic symmetry for LT-LiMn_{0.5}Ni_{0.5}O₂.
Space group: R-3m, a = 2.902 Å, c = 14.277 Å (c/a = 4.92),
R_{wp} = 8.80%

| Atom | Site | x | y | z | Occ | B_{eq} |
|---|---|---|---|---|---|---|
| Li1 | 3a | 0 | 0 | 0 | 0.838 | 1 |
| Li2 | 3b | 0 | 0 | 0.5 | 0.162 | 1 |
| Mn1 | 3a | 0 | 0 | 0 | 0.081 | 1 |
| Mn2 | 3b | 0 | 0 | 0.5 | 0.419 | 1 |
| Ni1 | 3a | 0 | 0 | 0 | 0.081 | 1 |
| Ni2 | 3b | 0 | 0 | 0.5 | 0.419 | 1 |
| O | 6c | 0 | 0 | 0.242 | 1 | 1.605 |

### Electrochemical Analysis

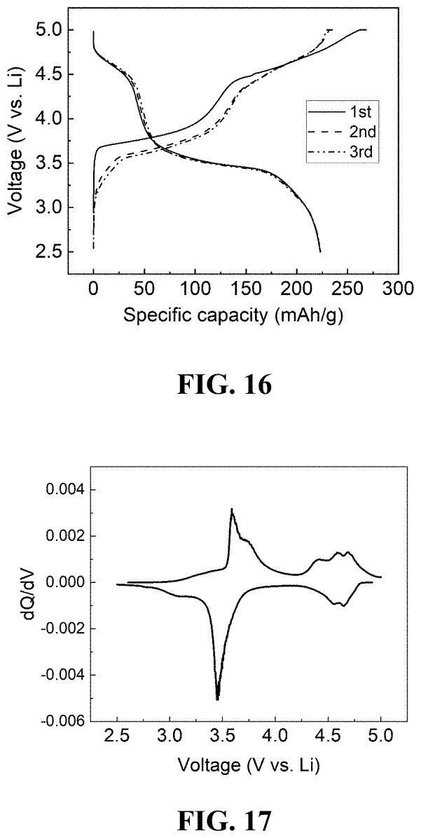

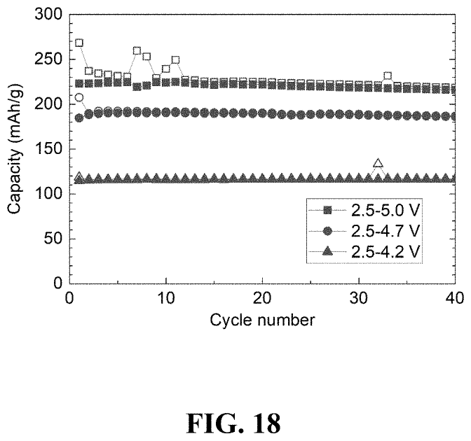

Li/LT-LiMn_{0.5}Ni_{0.5}O₂ cells were assembled and evaluated as described in Example 1. FIG. 16 shows the electrochemical profile of a Li/LT-Li₂MnNiO₄ (Li/LT-LiMn_{0.5}Ni_{0.5}O₂) lithium cell for the first three cycles between 5.0 and 2.5 V, delivering a discharge capacity of 225 mAh/g. The corresponding dQ/dV plot of the 3^{rd} cycle shows that the dominant reactions occur at approximately 3.6 V and 4.6 V, which involve two or more redox processes (FIG. 17). For the charge process, the low voltage (LV) plateau in FIG. 16 corresponds to the extraction of 0.9 Li from the LT-Li₂MnNiO₄ electrode structure and a specific capacity of about 130 mAh/g, while the high voltage (HV) plateau accounts for a further extraction of about 0.8 Li and a specific capacity of about 110 mAh/g. The reactions that occur on the LV plateau at approximately 3.6 V are attributed predominantly to the redox reactions of Ni²⁺ ions, whereas the reactions that occur on the HV plateau at approximately 4.6 V are attributed to reversible redox reactions of Ni³⁺ ions as well as the O²⁻ ions of the cubic-close-packed oxygen sublattice. The electrochemical capacities associated with the LV and HV plateaus during charge and discharge are different. While the HV and LV capacities are almost equal during charge, the HV capacity decreases to about 50 mAh/g (about 0.35 Li intercalation) whereas the LV capacity increases to about 170 mAh/g (about 1.2 Li intercalation). The asymmetry in the charge and discharge processes suggests that structural hysteresis occurs during the lithium extraction and insertion reactions. Nevertheless, Li/LT-Li₂MnNiO₄ cells exhibit excellent capacity-cycling stability when cycled 50 times between 2.5 to 4.2 V; 2.5 to 4.7 V; and 2.5 to 5.0 V (FIG. 18).

### Example 7—LT-LiNi_{1/3}Mn_{1/3}Co_{1/3}O₂

A partially-disordered lithiated spinel material, LiNi_{1/3}Mn_{1/3}Co_{1/3}O₂, also hereafter referred to as LT-NMC111 (where LT refers to the ‘low-temperature’ at which the material was synthesized (400-650° C.) relative to conventional ‘high-temperature’ (HT) solid state synthesis (800-900° C.)), was prepared by a flame spray pyrolysis (FSP) method as follows.

Stoichiometric amounts of nickel acetylacetonate, manganese acetylacetonate, and cobalt acetylacetonate in the required 1:1:1 Ni:Mn:Co_ratio for LT-NMC111, and a small excess of lithium propionate to compensate for lithium loss in the flame, typically about 1 to about 10% excess lithium, and preferably less than 10% excess lithium, were dissolved in acetonitrile and 2-ethylhexanoic acid (5:5 by volume) at a concentration of 0.31 mol/L. The precursor solution was then sprayed into the flame of a flame-spraying pyrolysis unit at Argonne National Laboratory. Samples of the resulting powder were subsequently fired at various temperatures ranging from 400 to 650° C. in air for 3-5 days.

### 1. X-Ray Diffraction

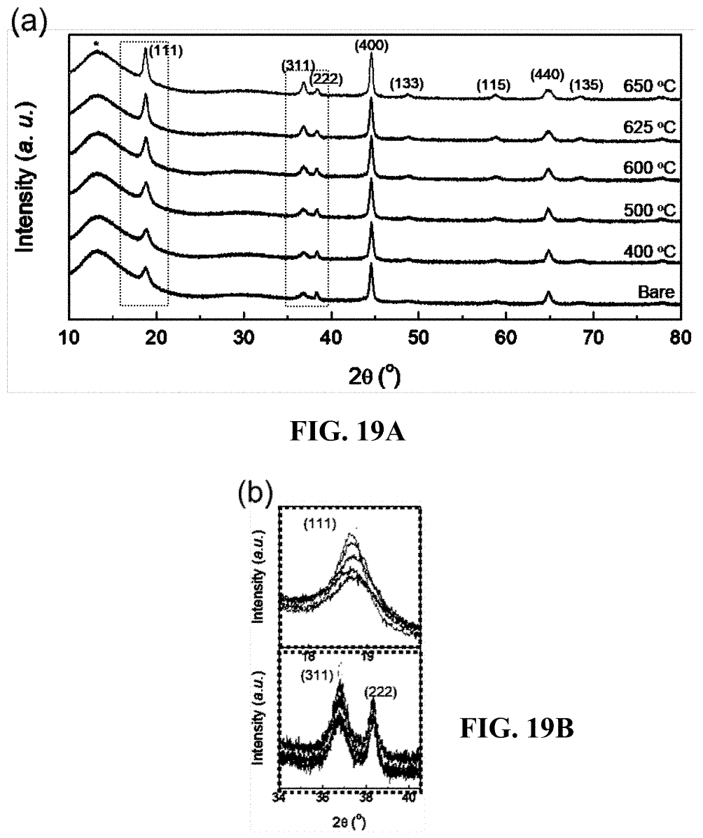

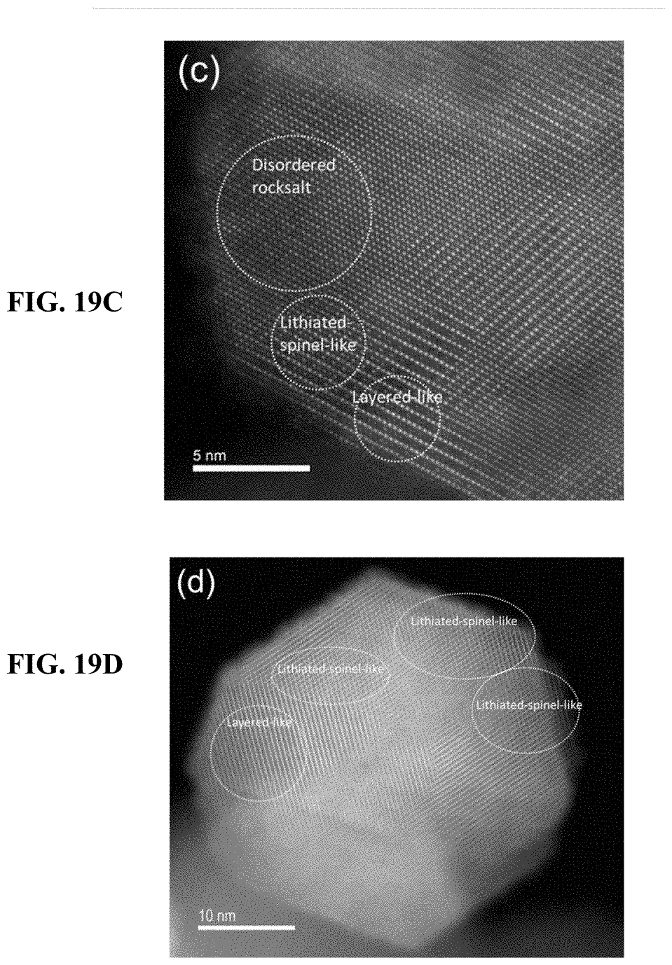

X-ray diffraction (XRD) patterns of the LT-NMC111 powders were obtained with a D8 ADVANCE, BRUKER diffractometer using Cu Kα radiation (λ=1.54178 Å). Structural parameters of the materials were determined by Rietveld profile refinement using the FULLPROF program. FIG. 19A shows the XRD pattern of a LT-NMC111 precursor sample prepared by the flame spray method (indicated as ‘Bare’ in FIG. 19A) and corresponding patterns after heating the precursor powder to 400, 500, 600, 625 and 650° C. The patterns of samples that had been heated at 400, 500 and 600° C. could be indexed to cubic symmetry, indicating that the oxygen array of the LT-NMC111 structure was cubic-close-packed. These peaks are indexed to the crystallographic space group Fd-3m, which is the prototypic symmetry of cubic spinel LiM₂O₄ structures and cubic lithiated-spinel structures Li₂M₂O₄ (M=metal ion). However, the LT-NMC111 samples heated to 625 and 650° C. show the onset of splitting of the 440 peak at approximately 65°2θ, which is more pronounced in the sample heated to 650° C. This peak splitting is indicative of a reduction in symmetry from cubic to trigonal that could occur, for example, during the transformation of a disordered lithiated-spinel structure to a more pronounced layered arrangement of the lithium and transition metal ions in alternating layers. The extent of ordering can be reflected by the crystallographic axial c/a ratio of a trigonal unit cell, which would vary from a value of 4.90 for an ideal cubic-close-packed oxygen lattice to >4.90 for a trigonal unit cell, which deviates from ideal cubic-close-packing. These subtle changes to the atomic arrangements in the structure are also evident from the changes in the relative peak intensities on increasing the temperature to which the samples were heated (FIG. 19B).

### 2. High Resolution Transmission Electron Microscopy

High-angle annular dark-field scanning transmission electron microscopy (HAADF-STEM) images of LT-NMC111 samples were obtained with an aberration-corrected JEOL electron microscope ARM200CF using an operation voltage of 200 kV. The image of an unheated precursor sample prepared by the flame spray pyrolysis (FSP) method, shown in FIG.

19C), provides evidence of an intergrown structure with lithiated-spinel-like and layered-like components as well as more randomly disordered, rock salt-type components. In contrast, FIG. 19D presents the STEM image of a LT-NMC111 sample heated to 625° C., which provides evidence of an intergrown structure comprised predominantly of layered- and lithiated spinel components, i.e., without significant evidence of the more randomly disordered rock salt configurations observed in the unheated FSP sample (cf. FIG. 19C).

### 3. Electrochemistry

a) Cell Assembly and Testing

A slurry of 80 wt % LT-NMC111 material, 10 wt % carbon black (SUPER P, Timcal), and 10 wt % polyvinylidene fluoride (PVDF, Solvay), dissolved in N-methyl-2-pyrrolidone (NMP), was cast onto Al foil. The NMP was removed by drying the coated Al foil at 80° C. in an oven overnight. The electrode was calendared before use. Coin cells (CR2032, Hohsen) were assembled with a LT-NMC111 cathode, a lithium metal disc anode, a CELGARD 2325 separator, and an electrolyte consisting of a 1.2 M solution of LiPF₆ in ethylene carbonate/ethyl methyl carbonate (EC/EMC, 3:7 by volume) in an Ar-filled glove box. The coin cells were charged and discharged using a MACCOR cycler (series 4000) between 2.7 and 4.3 V at 30° C. in a temperature-controlled chamber. Constant current, constant voltage charge and constant current discharge protocols were applied at a 0.2 C rate (1 C=100 mA/g) for the first 2 cycles to evaluate the relative electrochemical performance of the LT-NMC111 electrodes when heated to various temperatures.
b) Electrochemical Performance

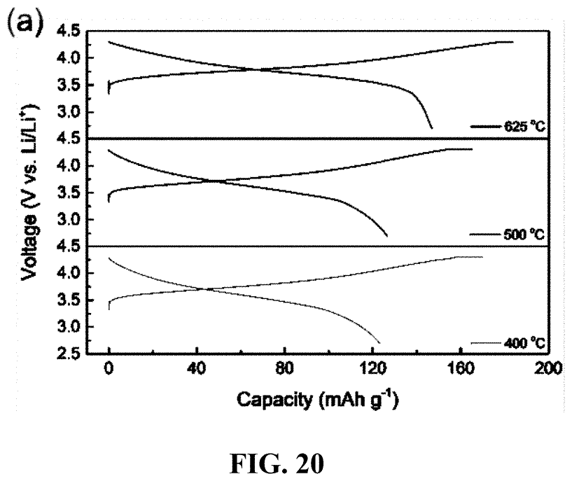

The voltage profiles for the initial charge/discharge cycle of Li/LT-NMC111 cells with cathodes that had been annealed at 400, 500 and 625° C. are shown in FIG. 20. The initial capacities of LT-NMC111 electrodes annealed at 400° C. and 500° C. were 123 and 126 mAh/g, respectively, whereas the LT-NMC111 provided a significantly higher capacity of 148 mAh/g.

This unexpected improvement in performance may be attributed to the absence, or significant reduction in the concentration of the more randomly disordered rock salt configurations observed in the HRTEM image of the LT-NMC111 electrodes annealed at 400° C. (cf. FIG. 19C).

### Electrochemical Cells and Batteries

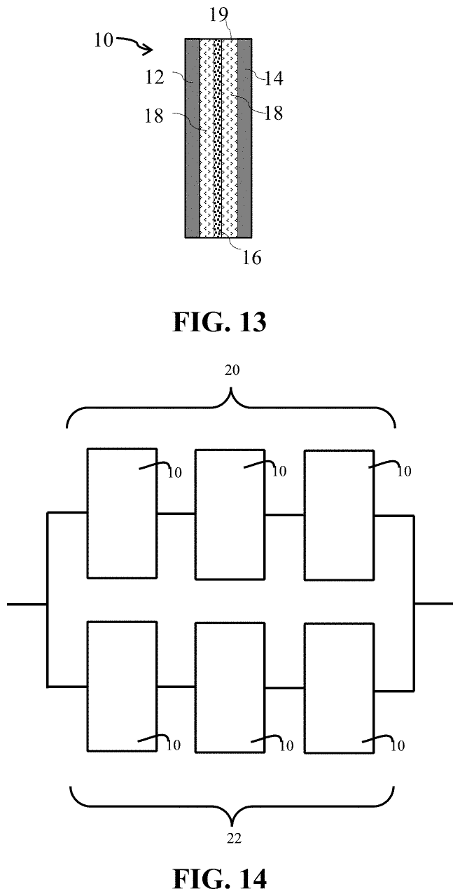

FIG. 13 schematically illustrates a cross-sectional view of a lithium-ion electrochemical cell 10 comprising first electrode 12 comprising a lithiated spinel electrode active material as described herein, and a second electrode 14, with separator 16 therebetween. A lithium-containing electrolyte 18 (e.g., comprising a solution of a lithium salt in a non-aqueous solvent) contacts electrodes 12 and 14 and separator 16. The electrodes, separator and electrolyte are sealed within housing 19. FIG. 14 schematically illustrates a lithium-ion battery comprising a first array 20 consisting of three series-connected electrochemical cells 10, and a second array 22 consisting of three series-connected electrochemical cells 10, in which first array 20 is electrically connected to second array 22 in parallel.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing materials or methods (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The terms “consisting of” and “consists of” are to be construed as closed terms, which limit any compositions or methods to the specified components or steps, respectively, that are listed in a given claim or portion of the specification. In addition, and because of its open nature, the term “comprising” broadly encompasses compositions and methods that “consist essentially of” or “consist of” specified components or steps, in addition to compositions and methods that include other components or steps beyond those listed in the given claim or portion of the specification. Recitation of ranges of values herein are merely intended to serve as a shorthand method of referring individually to each separate value falling within the range, unless otherwise indicated herein, and each separate value is incorporated into the specification as if it were individually recited herein. All numerical values obtained by measurement (e.g., weight, concentration, physical dimensions, removal rates, flow rates, and the like) are not to be construed as absolutely precise numbers, and should be considered to encompass values within the known limits of the measurement techniques commonly used in the art, regardless of whether or not the term “about” is explicitly stated. All methods described herein can be performed in any suitable order unless otherwise indicated herein or otherwise clearly contradicted by context. The use of any and all examples, or exemplary language (e.g., “such as”) provided herein, is intended merely to better illuminate certain aspects of the materials or methods described herein and does not pose a limitation on the scope of the claims unless otherwise stated. No language in the specification should be construed as indicating any non-claimed element as essential to the practice of the claims.

Preferred embodiments are described herein, including the best mode known to the inventors for carrying out the claimed invention. Variations of those preferred embodiments may become apparent to those of ordinary skill in the art upon reading the foregoing description. The inventors expect skilled artisans to employ such variations as appropriate, and the inventors intend for the claimed invention to be practiced otherwise than as specifically described herein. Accordingly, the claimed invention includes all modifications and equivalents of the subject matter recited in the claims appended hereto as permitted by applicable law. Moreover, any combination of the above-described elements in all possible variations thereof is encompassed by the claimed invention unless otherwise indicated herein or otherwise clearly contradicted by context.

1. A crystalline, structurally-integrated, lithium-metal-oxide composite electrode material of empirical formula LiM²_{(1-w)}M³_{w}O₂, wherein M² is a combination of Mn and Ni transition metal ions in a ratio of Mn to Ni ions of about 2:1 to about 1:1; M³ is one or more metal cations selected from the group consisting of an Al cation, a Ga cation, a Mg cation, a Ti cation; and a Co cation; and 0<w≤0.5; the crystal structure of the material of empirical formula LiM²_{(1-w)}M³_{w}O₂ comprises domains of a disordered lithiated-spinel component, and further comprises domains of a disordered layered component and optionally domains of a disordered rock salt component; the oxygen lattice of the components is cubic-close packed; and
wherein greater than 0 and less than 20 percent of lithium ions of the lithiated spinel and layered components are disordered among the octahedral sites normally occupied by the transition metal ions, and a corresponding percentage of the transition metal ions are disordered among the octahedral sites normally occupied by lithium ions, in fully-ordered, lithiated spinel and layered structures.

2. The material of claim 1, wherein greater than 10 percent and less than 20 percent of the lithium ions of the lithiated spinel and layered component structures are disordered among the octahedral sites normally occupied by the transition metals, and a corresponding percentage of the transition metal ions are disordered among the octahedral sites normally occupied by lithium ions, in fully ordered, lithiated spinel and layered structures.

3. The material of claim 1, wherein the ratio of Mn to Ni ions is about 1:1.

4. The material of claim 1, wherein M³ is Co and 0<w≤0.35.

5. The material of claim 1, wherein M³ is Co and 0.3<w≤0.35.

6. The material of claim 5, wherein the ratio of Mn to Ni ions is about 1:1.

7. The material of claim 5, wherein the ratio of Mn to Ni to Co ions is about 1:1:1.

8. The material of claim 1, wherein the lithium, M², M², and/or oxygen content of the material varies by up to about 5 percent from an ideal 1:(1-w):w:2 respective elemental stoichiometry.

9. The material of claim 1, wherein the cubic-close-packed oxygen lattice deviates from ideal cubic-close-packing such that the crystal symmetry of one or more of the components is lowered by an anisotropic variation of at least one lattice parameter length of the unit cell by up to about 5%.

10. The material of claim 1, wherein the cubic-close-packed oxygen lattice deviates from ideal cubic-close-packing such that the crystal symmetry of one or more of the components is lowered by an anisotropic variation of at least one lattice parameter length of the unit cell by up to about 2%.

11. The material of claim 1, further comprising fluorine in place of a portion of the oxygen in the material of formula LiM²_{(1-w)}M³_{w}O₂; wherein less than 10 atom percent of the oxygen is replaced by fluorine.

12. An electrode active composition for an electrochemical cell comprising a first electrode active material mechanically blended with or structurally integrated with a second electrode active material, wherein the first electrode active material is the material of claim 1;
and the second electrode active material comprises one or more additional lithium metal oxide materials different from the first electrode active material.

13. An electrode for a lithium electrochemical cell comprising particles of an electrode active material in a binder matrix coated on a metal or carbon current collector; wherein the electrode active material comprises the material of claim 1.

14. An electrochemical cell comprising an anode, a cathode, and a lithium-containing electrolyte contacting the anode and cathode, wherein the cathode comprises the electrode of claim 13.

15. A battery comprising a plurality of electrochemical cells of claim 14 electrically connected in series, in parallel, or in both series and parallel.

16. A method from preparing the material of claim 1, comprising the steps of (a) atomizing a precursor solution with oxygen to form liquid droplets; (b) spraying the liquid droplets into a methane/oxygen pilot flame of a flame-spray pyrolysis unit to produce vaporize and oxidize the droplets to form a precursor powder; and (c) heating the precursor powder in air or oxygen at a selected temperature in the range of about 400 to about 650° C. to form the material of empirical formula LiM²_{(1-w)}M³_{w}O₂; wherein M² is a combination of Mn and Ni transition metal ions in a ratio of Mn to Ni ions of about 2:1 to about 1:1; M³ is one or more metal cations selected from the group consisting of an Al cation, a Ga cation, a Mg cation, a Ti cation; and a Co cation; and 0<w≤0.5; and wherein the precursor solution comprises a Li salt, a M² salt, and a M³ salt are dissolved in a non-aqueous solvent or an aqueous solvent in stoichiometrically-required amounts required to achieve a target ratio of 1:(1-w):w:2, and optionally, the lithium salt is present in the precursor solution in a molar excess of less than about 10 mol %.

17. The method of claim 16, wherein the precursor powder is heated at a selected temperature in the range of about 400 to about 600° C.

18. The method of claim 16, further comprising, before step (a), preparing the precursor solution by dissolving the Li salt, the M² salt, and the M³ salt in an aqueous solvent or a non-aqueous solvent; wherein optionally the Li salt is included in an excess of up to about 10 mol %.

19. The method of claim 16, wherein each of the Li salt, the M² salt, and the M³ salt is a salt of an organic acid.

20. The method of claim 19, wherein the organic acid is selected from the group consisting of acetic acid, propionic acid, and acetylacetic acid.

21. The method of claim 16, wherein the solvent is an organic solvent.

22. The method of claim 16, wherein the solvent is selected from the group consisting of acetonitrile, 2-ethylhexanoic acid, and a combination thereof.
